(19) United States
(12) Patent Application Publication
(10) Pub. No.: US 2016/0148109 A1
(43) Pub. Date: May 26, 2016

(54) System for Motion Analytics and Method for Analyzing Motion

(71) Applicant: Hitachi, Ltd., Tokyo (JP)

(72) Inventors: Jun-Ichiro WATANABE, Tokyo (JP); Kazuo YANO, Tokyo (JP)

(21) Appl. No.: 15/009,105

(22) Filed: Jan. 28, 2016

Related U.S. Application Data
(63) Continuation of application No. PCT/JP2013/070620, filed on Jul. 30, 2013.

(51) Int. Cl. G06N 5/04

(52) U.S. Cl. CPC G06N 5/047

(57) ABSTRACT

A system for motion analytics includes acceleration sensors and selectively infrared sensors or microphones. The system also includes a processor and display device. The processor identifies test scores obtained by subjects. The processor also computes degrees of similarities in the real-time physical movements between the at least two groups of subjects using the acceleration sensors, and an amount of time during which some subjects among the at least two groups of subject are engaged in communication using the infrared sensors and/or the microphones. Further, the processor analyzes a correlation between the test scores and the degrees of similarities, and between the test scores and the amount of communication time. The processor then predicts an improvement in the test scores based on patterns in the analysis of the correlation. The predicted improvement of the test scores is then displayed on the display device.

### BACKGROUND

Embodiments of the present invention relate to a system and a method for identifying a factor correlating with scholastic performance and a system for presenting such factor. More particularly, embodiments of the present invention relate to a system and method that thoroughly analyze large amounts of data reflecting interhuman relations and various human behaviors which are measured by wearable sensors, sensors built in mobile phones, or other means and attains improvement or the like in scholastic performance at schools and tutoring schools or the like.

Education is an issue of high interest in all the countries of the world. The Organization for Economic Co-operation and Development (OECD) has conducted the Programme for International Student Assessment (PISA) for fifteen and sixteen children every three years since 2000. The International Association for the Evaluation of Educational Achievement (IEA) also has conducted Trends in International Mathematics and Science Study (TIMSS) for students from the fifth grade to the eighth grade since 1995. Based on these survey results, reviewing school systems and education contents is considered by governments. In some countries, the market size of tutoring schools and preparatory schools remains flat or tends to decline, as the number of children decreases. In Asian countries, however, the market of tutoring schools grows year by year and a demand for supplementary lessens at tutoring schools is increasing.

In the fields of educational psychology and economics, many studies are made on factors influencing scholastic performance. These studies center on two key subjects: one investigating relationship between home environment and scholastic ability and the other investigating relationship between school environment and scholastic ability. According to these studies, what determines scholastic performance is home environment and the influence of school environment is small [J. S. Coleman, et al., Equality of Educational Opportunity, U.S. Govt. Print. Off. (Washington, 1966).](hereinafter referred to as Non-patent Document 1) and [E. A. Hanushek, Assessing the Effects of School Resources on Student Performance: An Update, Educational Evaluation and Policy Analysis 19(2), pp. 1.41-1.64 (1997)](hereinafter referred to as Non-patent Document 2). That is, factors that cannot be controlled by school operators, such as household income level and childhood life have stronger influence on scholastic performance than factors that can be controlled by school operators, such as class size and investment in training of teachers. As for class size effects, there are still many points to argue and, in the current situation, no one can say that class size has a determinative effect [L. Mishel, R. Rothstein, A. B. Krueger, E. A. Hanushek and J. K. Rice, The Class Size Debate, Economic Policy Institute (2002)](hereinafter referred to as Non-patent Document 3). Furthermore, classmate effects (peer effects) are verified in countries and it is reported that classmates have a certain effect [A. Ammermueller and J. S. Pischke, Peer Effects in European Primary Schools: Evidence from PIRLS, Working Paper 12180, National Bureau of Economic Research, 2006](hereinafter referred to as Non-patent Document 4). However, its mechanism is unrevealed and organizing classes is mostly performed based on past experience at schools and tutoring schools. Analysis of scholastic factors in these preceding studies investigates differences in a management way, such as organizing classes, and relationship between teacher's skill and student's scholastic performance, but does not focus attention on human behaviors in the real world, such as face-to-face interaction between a student and a teacher or among students and physical activity.

On the other hand, along with the development of sensor technology and the popularization of mobile phones and social network services, large amounts of data reflecting human behaviors in the real world and cyberspace are momentarily accumulated in bulk. Studies that analyze correlation between such human behavior data and corporate productivity are actively conducted. In consequence, it is revealed that a human behavior which appears random at first viewing has some sort of pattern and follows a law. It is also revealed that a particular pattern correlates with productivity such as business results [A. S. Pentland, The New Science of Building Great Teams, Harvard Business Review 90 (4), pp. 60-69 (2012)](hereinafter referred to as Non-patent Document 5). Furthermore, a technique that designates a behavior that has influence on objective assessment, such as organization productivity and trouble/faults, and subjective assessment, such as leadership/teamwork, worth doing/fulfillment, and stress/mental is also proposed [Published PCT International Application No. WO2011/055628](hereinafter referred to as Patent Document 1).

### SUMMARY

In the abovementioned Non-patent Documents 1 and 2, an investigation is made of relationship between home environment and scholastic performance, based on a questionnaire survey. Thus, it is difficult to remove ambiguity included in survey results and conduct a timely survey along with a change in educational environment and what is presented is just a qualitative tendency.

In the abovementioned Non-patent Document 3, various arguments are made about class size effects including an argument that questions its effect. This means that it is not assured that control of class size by school operators leads to improvement in scholastic performance.

In the abovementioned Non-patent Document 4, descriptions are provided about classmate effects (peer effects) in which a student in a class with more classmates who make a fine record becomes to make a fine record and, in countries, it is reported that classmates have a certain effect. However, its mechanism is not clarified well and designing classes is performed based on school operator's experience.

In fact, in previously conducted studies on factors which relate to improvement in scholastic performance, several candidates of qualitative factors are specified, but they are not useful as a sufficient criterion for decision-making for school operators to design a policy for improving scholastic performance based on a quantitative decision. In other words, factors having influence on scholastic performance which can be controlled by school operators are not found. This is due to the following reasons: indicators for evaluating quantitative effects are not developed; and it is difficult to collect data in quantity and quality required to develop the indicators for evaluating quantitative effects and such data does not exist.

On the other hand, in the abovementioned Non-patent Document 5, it is possible to accumulate large amounts of data reflecting human behaviors using sensor technology, mobile phones, and social network services. However, such human behavior data is used for analyzing correlation between human behavior and corporate productivity or the like. Also in the abovementioned Patent Document 1, human behavior data is used to designate a behavior that has influence on organization productivity and trouble/faults among others. Therefore, the approaches described in Non-patent Document 5 and Patent Document 1 are not those concerning factors which relate to improvement in scholastic performance at schools or the like in educational environment.

Thus, embodiments of the present invention have been developed to solve such a problem and its representative object is to provide a technique for identifying and presenting a quantitative indicator that has influence on scholastic performance in educational environment.

The above and other objects and novel features of the embodiments of the present invention will become apparent from the description in the present specification and the accompanying drawings.

A representative aspect of the embodiments of the present invention disclosed in this application is outlined below.

(1) A representative method for identifying a factor correlating with scholastic performance is a method for identifying a factor correlating with scholastic performance in an educational environment involving a first person and a plurality of second persons who differ in roles from the first person. The above method for identifying a factor correlating with scholastic performance includes a first step of analyzing, with a computer, relational patterns between the first person and the plurality of second persons and among the second persons, based on face-to-face data and a physical quantity between the first person and the second persons measured by a plurality of sensors attached to the first person and the second persons respectively, and a second step of analyzing, with the computer, correlation between the relational patterns and performance data of the second persons, thus analyzing which of the relational patterns strongly correlates with performance.

(2) A representative system for presenting a factor correlating with scholastic performance is a system for presenting a factor correlating with scholastic performance in an educational environment involving a first person and a plurality of second persons who differ in roles from the first person. The above system for presenting a factor correlating with scholastic performance includes a computer that analyzes relational patterns between the first person and the plurality of second persons and among the second persons, based on face-to-face data and a physical quantity between the first person and the second persons measured by a plurality of sensors attached to the first person and the second persons respectively, and analyzes correlation between the relational patterns and performance data of the second persons, thus analyzing which of the relational patterns strongly correlates with performance.

An advantageous effect that will be achieved by a representative aspect of the embodiments of the present invention disclosed in this application is outlined below.

An advantageous effect which is representative is as follows: it is possible to identify and present a quantitative indicator having influence on scholastic performance in educational environment.

### BRIEF DESCRIPTION OF THE DRAWINGS

FIG. 1 is a schematic diagram illustrating an example of a process flow of a method for identifying a factor correlating with scholastic performance and a system for presenting such factor, according to one embodiment of the present invention;

FIG. 2 is a block diagram depicting an example of structure of the system for presenting a factor correlating with scholastic performance, according to one embodiment of the present invention;

FIG. 3A is a diagram presenting an example of a data set which is stored in a face-to-face information database, according to one embodiment of the present invention;

FIG. 3B is a diagram presenting an example of a face-to-face interaction network, according to one embodiment of the present invention;

FIG. 4 is a diagram presenting an example of a data set which is stored in an acceleration database, according to one embodiment of the present invention;

FIG. 5 is a diagram presenting an example of a data set which is stored in a user attribute database, according to one embodiment of the present invention;

FIG. 6 is a diagram presenting an example of the acceleration waveforms of a teacher and a student and converting them to a notation using arrows, according to one embodiment of the present invention;

FIG. 7 is a flowchart illustrating an example of a process of analyzing correlation between physical movement synchronism between a teacher and students and scholastic performance, according to one embodiment of the present invention;

FIG. 8A is a scatter diagram presenting an example of a result of an experiment in which an evaluation is made of correlation between a pattern (P↓↑) of physical movement synchronism between a teacher and students and scholastic performance, according to one embodiment of the present invention;

FIG. 8B is a scatter diagram presenting an example of a result of an experiment in which an evaluation is made of correlation between a pattern (P↓↓) of physical movement synchronism between a teacher and students and scholastic performance, according to one embodiment of the present invention;

FIG. 9 is a diagram presenting an example of separating an acceleration waveform among students into active and non-active states, according to one embodiment of the present invention;

FIG. 10 is a flowchart illustrating an example of a process of analyzing correlation between physical movement synchronism among students and scholastic performance, according to one embodiment of the present invention;

FIG. 11 is a scatter diagram presenting an example of a result of an experiment in which an evaluation is made of correlation between a degree of unity of physical movement among students who constitute a class and the class's scholastic performance, according to one embodiment of the present invention;

FIG. 12 is a diagram depicting an example of a face-to-face interaction network drawn using face-to-face information, according to one embodiment of the present invention;

FIG. 13A is a scatter diagram presenting an example of a result of an experiment in which an evaluation is made of correlation between an indicator (degree) in the face-to-face interaction network of students and a teacher constituting a class and the class's scholastic performance, according to one embodiment of the present invention;

FIG. 13B is a scatter diagram presenting an example of a result of an experiment in which an evaluation is made of correlation between an indicator (clustering coefficient) in the face-to-face interaction network of students and a teacher constituting a class and the class's scholastic performance, according to one embodiment of the present invention;

FIG. 14 is a flowchart illustration an example of a process of analyzing correlation between an indicator of face-to-face communication and scholastic performance, according to one embodiment of the present invention;

FIG. 15A is a diagram presenting an example of a screen displaying a result (for student A) of analyzing correlation between physical movement synchronism between a teacher and students and scholastic performance, according to one embodiment of the present invention;

FIG. 15B is a diagram presenting an example of a screen displaying a result (for student B) of analyzing correlation between physical movement synchronism between a teacher and students and scholastic performance, according to one embodiment of the present invention;

FIG. 16A is a diagram presenting an example of a screen displaying a result (for class A) of analyzing correlation between physical movement synchronism among students and scholastic performance, according to one embodiment of the present invention;

FIG. 16B is a diagram presenting an example of a screen displaying a result (for class B) of analyzing correlation between physical movement synchronism among students and scholastic performance, according to one embodiment of the present invention;

FIG. 17 is a diagram presenting an example of a screen displaying a result of analyzing correlation between an indicator of face-to-face communication and scholastic performance, according to one embodiment of the present invention;

FIG. 18A is a scatter diagram presenting an example of simulation experiment result (for an individual student), according to one embodiment of the present invention; and

FIG. 18B is a scatter diagram presenting an example of simulation experiment result (for a class), according to one embodiment of the present invention.

### DETAILED DESCRIPTION

In the following description of embodiment, an embodiment is divided into plural sections or embodiments, when necessary for convenience sake, and these sections or embodiments are described; they are not independent of each other, unless otherwise specified, and they relate to one another such that one is an example of modification to, further detail of, or supplementary description, etc. of another in part or whole. In the following description of embodiment, where the number of elements (including the number of pieces, a numeric value, quantity, range, etc.) is mentioned, that number should not be limited to a particular number mentioned and may be more or less than the particular number, unless otherwise specified and unless that number is, in principle, obviously limited to the particular number.

In addition, for an embodiment which will be described below, needless to say, its components (including constituent steps or the like) are not always necessary, unless otherwise specified and unless such components are, in principle, considered to be obviously necessary. Likewise, in an embodiment which will be described below, when the shape of a component or the like, a positional relation between components, etc. are described, such description should be construed to include those that are substantially similar or analogous to the shape or the like, unless otherwise specified and unless such description is, in principle, considered to be obviously exclusive. This is also true for numeric values and ranges mentioned above.

### General Description of Embodiment

To begin with, embodiment is generally described. In the general description of embodiment, descriptions are provided, while referring to corresponding components of an embodiment with their reference numerals or the like in parentheses.

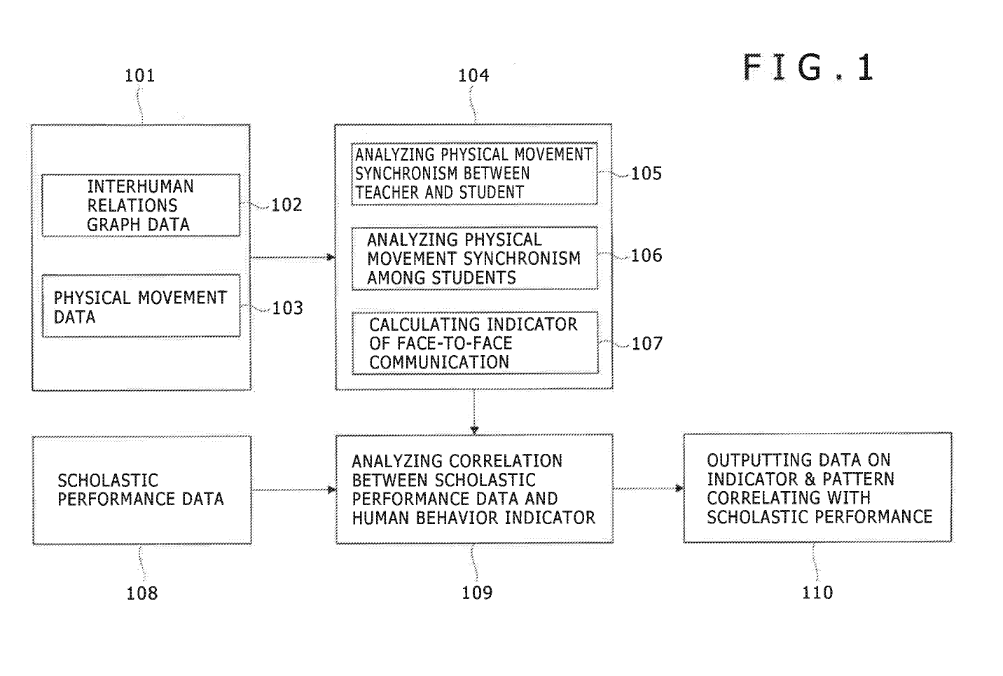

(1) An exemplary embodiment of a method for identifying a factor correlating with scholastic performance is a method for identifying a factor correlating with scholastic performance in an educational environment involving a first person and a plurality of second persons who differ in roles from the first person. The above method for identifying a factor correlating with scholastic performance includes a first step (steps 105, 106, and 107) of analyzing, with a computer, relational patterns between the first person and the second persons and among the second persons, based on face-to-face data (interhuman relations graph data 102) and a physical quantity (physical movement data 103) between the first person and the second persons measured by a plurality of sensors attached to the first person and the second persons respectively, and a second step (step 109) of analyzing, with the computer, correlation between the relational patterns and performance data (scholastic performance data (step 108)) of the second persons, thus analyzing which of the relational patterns strongly correlates with performance (FIG. 1).

More preferably, the first person is a teacher, the second persons are students, and the educational environment is a school. The first step includes analyzing relational patterns between the teacher and the plurality of students and among the students, based on face-to-face data and a physical quantity between the teacher and the students measured by a plurality of sensors attached to the teacher and the students respectively. The second step includes analyzing correlation between the relational patterns and scholastic performance data of the students, thus analyzing which of the relational patterns strongly correlates with scholastic performance.

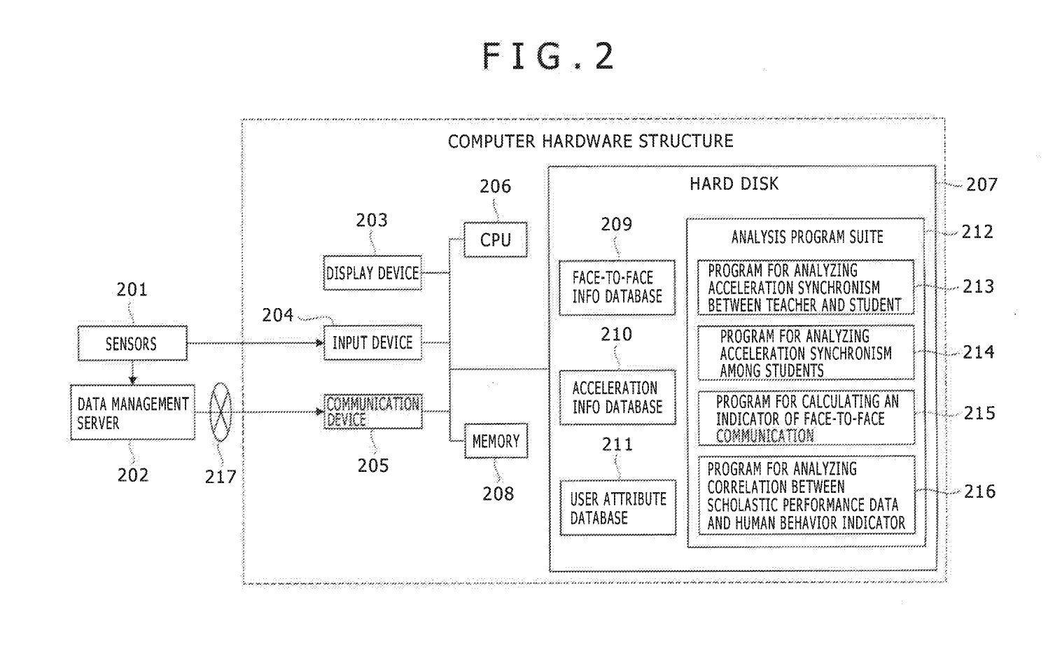

(2) An exemplary embodiment of a system for presenting a factor correlating with scholastic performance is a system for presenting a factor correlating with scholastic performance in an educational environment involving a first person and a plurality of second persons who differ in roles from the first person. The above system for presenting a factor correlating with scholastic performance includes a computer that analyzes relational patterns between the first person and the plurality of second persons and among the second persons (programs 213, 214, and 215) based on face-to-face data (a face-to-face information database 209) and a physical quantity (an acceleration information database 210) between the first person and the second persons measured by a plurality of sensors (sensors 201) attached to the first person and the second persons respectively, and analyzes correlation between the relational patterns and performance data (a user attribute database 211) of the second persons, thus analyzing which of the relational patterns strongly correlates with performance (a program 216) (FIG. 2).

More preferably, the first person is a teacher, the second persons are students, and the educational environment is a school. The computer analyzes relational patterns between the teacher and the plurality of students and among the students, based on face-to-face data and a physical quantity between the teacher and the students measured by a plurality of sensors attached to the teacher and the students respectively, and analyzes correlation between the relational patterns and scholastic performance data of the students, thus analyzing which of the relational patterns strongly correlates with scholastic performance.

(3) Other features of an embodiment which is generally described herein are as follows.

In an embodiment described herein, a method of measuring interhuman relations in a school environment quantitatively and continuously using sensors and identifying an indicator of human behavior correlating with scholastic performance from large amounts of human behavior data thus measured is provided and a presentation system that assists in designing a policy for improving scholastic performance by controlling the indicator is provided. Specifically, there are provided a method and system for measuring face-to-face data between a teacher and students and a physical quantity such as acceleration data reflecting physical movement, analyzing relational patterns between a teacher and students and among the students, analyzing correlation between the relational patterns and performance of the students, thus analyzing which of the relational patterns strongly correlates with performance.

Data to be analyzed in an embodiment described herein is general data representing a status of communication between persons, which is referred to as interhuman relations graph data herein. Such data is obtained by wearable sensors such as sensor nodes of a name tag form embedded with an infrared sensor and/or miniature microphone, these sensors being attached to members such as students, teachers, clerks, etc. in a school, tutoring school, etc. and is the data obtained by quantitatively measuring face-to-face communication between persons. From such data, a network structure can be obtained by making nodes stand for persons and drawing a link between persons engaged in communication. Wearable sensors may be watch type sensor nodes or the like, besides the sensor nodes of a name tag form. Interhuman relations graph data may be data reflecting connections between persons, which are unconsciously configured, such as mobile phone usage logs and transmission/reception relations, in addition to face-to-face data which can be measured by the above wearable sensors which persons wear consciously. By evaluating correlation between data that captures such interhuman relations quantitatively and scholastic performance, it would become possible to quantitatively evaluate relation between interhuman relations in a school environment and scholastic performance.

Also, data to be analyzed in an embodiment described herein is physical movement of members such as students and teachers in a school, tutoring school, etc., which is obtained from acceleration sensors embedded in the above wearable sensors and mobile phones or the like and which is referred to as physical movement data herein. From such data, it is possible to quantitatively measure, e.g., vigorousness per class and grade in a school, physical reaction of students to teacher's behavior, physical synchronism among students, etc. and evaluate their correlation with scholastic performance.

In an embodiment described herein, there is also provided a method of inputting scores of tests, e.g., monthly or weekly periodic tests, which are conducted in a school for learning level check, and the interhuman relations graph data and physical movement data, calculating correlation between various indicator and human behavior patterns derived from the interhuman relations graph data and physical movement and the test scores, and identifying an indicator or pattern having a high correlation with the test scores.

In an embodiment described herein, there is also provided a presentation system that effectively presents an identified indicator or pattern correlating with scholastic performance to assist school operators or the parents of students in designing a policy for improving scholastic performance. This makes it possible to present a quantitatively controllable indicator based on human behavior in school environment, so that school operators, teachers, students themselves, or their parents can take action for improving scholastic performance quickly and efficiently.

In an embodiment described herein, there is also provided a method of predicting how scholastic performance will change by changing an identified indicator.

Advantageous effects of an embodiment which is generally described herein are as follows. According to an embodiment described herein, it would become possible to identify and present an indicator or pattern relating to scholastic performance quantitatively and automatically from large amounts of human behavior data. According to an embodiment described herein, it would become possible to design an education system based on qualitative human behavior data, instead of a qualitative decision by experience of teachers and school operators among others. According to an embodiment described herein, it would become possible to predict how scholastic performance will change by changing the relation between a teacher and students and the relation among students in school environment. According to an embodiment described herein, it would become possible to effectively implement designing a practical policy for improving scholastic performance by identifying an indicator based on quantitative data and presenting its correlation with scholastic performance effectively.

In the following, based on the drawings, detailed descriptions are provided about one embodiment based on the foregoing general description of embodiment. In all drawing for explaining one embodiment, elements having corresponding functions are assigned the same reference numerals and their repeated description is omitted.

### One Embodiment

Using FIGS. 1 to 18, descriptions are provided about a method for identifying a factor correlating with scholastic performance and a system for presenting such factor according to one embodiment.

In the present embodiment, descriptions are provided, taking a school as an example of an educational environment involving a first person and plural second persons who differ in roles from the first person, but there is no limitation to this. The embodiment is also applicable to other educational environments such as a tutoring school and a preparatory school.

### <Process Flow>

First, descriptions are provided for a process flow of the method for identifying a factor correlating with scholastic performance and the system for presenting such factor according to the present embodiment. More specifically, FIG. 1 illustrates an overall flow of a process of identifying a factor correlating with scholastic performance from human behavior data in a school environment and eventually presenting a policy for improving scholastic performance based on the factor.

In FIG. 1, reference numeral 101 denotes a step of inputting interhuman relations graph data which represents interhuman relations and physical movement data. In this input step 101, reference numeral 102 denotes interhuman relations graph data which is face-to-face information which is obtained based on information from infrared sensors or the like and reference numeral 103 denotes physical movement data which is obtained based on information from acceleration sensors o the like. Reference numeral 104 denotes a step of analysis processing on interhuman relations graph data and physical movement data. In this analysis processing step 104, reference numeral 105 denotes a step of analyzing physical movement (acceleration waveform) synchronism between a teacher and students, reference numeral 106 denotes a step of analyzing physical movement (acceleration waveform) synchronism among students, and reference numeral 107 denotes a step of calculating an indicator of face-to-face communication between a teacher and students or among students. Reference numeral 108 denotes a step of inputting scholastic performance data which is an indicator of productivity in education. Reference numeral 109 denotes a step of analyzing correlation between scholastic performance data input by the input step 108 and a human behavior indicator which is a result of the analysis processing step 104. Reference numeral 110 denotes a step of outputting data on an indicator and a pattern correlating with scholastic performance, identified as the result of the correlation analysis step 109.

In the input step 101 of interhuman relations graph data and physical movement data, the interhuman relations graph data 102 is network-transmitted information reflecting face-to-face data and face-to-face interaction and this information is obtained by wearable sensors embedded with an infrared sensor, which have been attached to persons and which are, e.g., of a name tag form. Although communication data which is obtained through, e.g., mobile phone and e-mail usage logs may be used alternatively, descriptions are provided here, taking face-to-face communication as an example. In this case, network nodes are persons and a link between nodes is put according to such a rule that, if persons communicate with each other for a certain amount of time or longer, a link is put between the nodes (corresponding to the persons). Instead of interhuman relations graphs which are thus created by means of wearable sensors which persons wear consciously, information reflecting connections between persons which can be developed from mobile phone usage logs and e-mail transmission/reception records among others may be input as interhuman relations graphs.

In the input step 101 of interhuman relations graph data and physical movement data input, the physical movement data 103 is information concerning physical movement and this information is obtained by wearable sensors embedded with an acceleration sensor, which have been attached to persons and which are, e.g., of a name tag form. Specifically, this information includes the number of physical vibrations for a given period of time, e.g., one second among others. Instead of data representing physical movement which is thus obtained by means of wearable sensors which persons wear consciously, data representing physical movement which is obtained from mobile phones or the like may be input.

The step 104 of analysis processing on interhuman relations graph data and physical movement data is processing as follows: executing the step 105 of analyzing acceleration waveform synchronism between a teacher and students, the step 106 of analyzing acceleration waveform synchronism among students, and the step 107 of calculating an indicator of face-to-face communication from the interhuman relations graph data 102 and the physical movement data 103 which have been input at step 101.

The step 105 of analyzing acceleration waveform synchronism between a teacher and students is processing as follows: from the physical movement data 103, sequencing in time series numeric data representing physical movement, e.g., zero cross counts of an acceleration signal, i.e., the number of times the acceleration signal has passed across the zero level for a unit time, and evaluating a degree of coincidence between time series fluctuation of numeric data representing the physical movement of a teacher and time series fluctuation of numeric data representing the physical movement of a student.

The step 106 of analyzing acceleration waveform synchronism among students is processing as follows: from the physical movement data 103, sequencing in time series numeric data representing physical movement, e.g., zero cross counts of an acceleration signal, and evaluating a degree of coincidence between the time series fluctuations of numeric data representing the physical movements of plural students.

The step 107 of calculating an indicator of face-to-face communication is processing as follows: from the interhuman relations graph data 102, calculating a degree, a clustering coefficient, node-to-node distance, etc. in a face-to-face interaction network diagram which represents face-to-face relations.

The step 108 of inputting scholastic performance data is processing as follows: inputting scholastic performance data reflecting students' scholastic performances such as a learning level checking test.

The step 109 of analyzing correlation between scholastic performance data and a human behavior indicator is processing as follows: calculating a correlation between a human behavior indicator calculated by the step 104 of analysis processing on interhuman relations graph data and physical movement data and scholastic performance data such as test scores which have been input by the step 108 of inputting that data.

The step 110 of outputting data on an indicator and a pattern correlating with scholastic performance is processing as follows: displaying, in a graph or the like, an indicator and a human behavior pattern correlating with scholastic performance, identified as the result of the step 109 of analyzing correlation between scholastic performance data and a human behavior indicator. This step may display, for example, time sequence data of the acceleration waveforms of a teacher and a student, time sequence data of the acceleration waveforms of students, a face-to-face interaction network diagram, face-to-face information in a matrix form, or other information. In addition to these items of information which may be displayed, this step may also present information that may assist in designing a policy for improving scholastic performance, such as the name of a student characterized by an extremely small quantity of face-to-face communication with a teacher or the name of a student characterized by an extremely low degree of activity (physical movement) during lessons. These items of output may be displayed on a display or printed on paper or the like.

### <System Structure>

Then, a structure of a system for presenting a factor correlating with scholastic performance according to the present embodiment is described with FIG. 2. FIG. 2 is a block diagram depicting an example of structure of the system for presenting a factor correlating with scholastic performance. More specifically, FIG. 2 depicts an overall system structure comprised of a computer hardware structure, sensors, and a data management server via an Internet network.

In FIG. 2, reference numeral 201 denotes sensors for measuring interhuman relations graph data and physical movement data. Reference numeral 202 denotes a data management server on which interhuman relations graph data, physical movement data, scholastic performance data, etc. are stored. Reference numeral 203 denotes a display device; 204 denotes an input device; 205 denotes a communication device; 206 denotes a CPU; 207 denotes a hard disk; and 208 denotes a memory. Reference numeral 209 denotes a face-to-face information database storing face-to-face time information which is interhuman relations graph data; 210 denotes an acceleration information database storing acceleration information; and 211 denotes a user attribute database storing index values for each user among others. Reference numeral 212 denotes an analysis program suite. In the analysis program suite 212, reference numeral 213 denotes a program for analyzing acceleration synchronism between a teacher and students; reference numeral 214 denotes a program for analyzing acceleration synchronism among students; 215 denotes a program for calculating an indicator of face-to-face communication; and 216 denotes a program for analyzing correlation between scholastic performance data and a human behavior indicator. Reference numeral 217 denotes an Internet network.

Interhuman relations graph data is face-to-face information, such as “measured time in minutes of face-to-face communication between two identified persons”, which is obtained by infrared sensors embedded in wearable sensors which are, e.g., of a name tag form.

Physical movement data is information representing a degree of physical movement, such as “the number of physical vibrations for one minute”, which is obtained from acceleration sensors embedded in the sensors of a name tag form or mobile phones.

Interhuman relations graph data and physical movement data are input directly from the sensors 201 to the input device 204 of the system or such data accumulated on the data management server 202 is transmitted via the Internet network 217, received through the communication device 205, and stored into the hard disk 207.

Scholastic performance data reflecting scholastic performance, such as test scores, is directly input to the input device 204 of the system in a manual input manner or the like or such data accumulated on the data management server 202 is transmitted via the Internet network 217, received through the communication device 205, and stored into the hard disk 207.

Interhuman relations graph data which has been input via the input device 204 or the communication device 205 and will be subjected to analysis is once stored into the face-to-face information database 209 in the hard disk 207.

Scholastic performance data which has been input via the input device 204 or the communication device 205 and will be subjected to analysis is once stored into the user attribute database 211 in the hard disk 207.

Users' attribute values (teacher/student distinction, sexuality, grade information, etc.) which has been input via the input device 204 or the communication device 205 and will be subjected to analysis is once stored into the user attribute database 211 in the hard disk 207.

When analyzing acceleration synchronism between a teacher and students and analyzing acceleration synchronism among students, information on acceleration stored in the acceleration information database 210 stored on the hard disk 207 is read and loaded into the memory 208. The CPU 206 executes the program 213 for analyzing acceleration synchronism between a teacher and students and the program 214 for analyzing acceleration synchronism among students in the analysis program suite 212. Thereby, calculation is executed and its result is recorded into the user attribute database 211.

When calculating an indicator of face-to-face communication, information on face-to-face communication stored in the face-to-face information database 209 stored on the hard disk 207 is read and loaded into the memory 208. The CPU 206 executes the program 215 for calculating an indicator of face-to-face communication in the analysis program suite 212. Thereby, calculation is executed and its result is recorded in to the user attribute database 211.

When analyzing correlation between scholastic performance data and a human behavior indicator, information on scholastic performance such as test scores stored in the user attribute database 211 stored on the hard disk 207, an indicator of face-to-face communication calculated by the program 215 for calculating such indicator, and indicators of acceleration calculated by the programs 213 and 214 for analyzing acceleration synchronism are read and loaded into the memory 208. The CPU 206 executes the program 216 for analyzing correlation between scholastic performance data and a human behavior indicator in the analysis program suite 212. Thereby, calculation is executed.

Respective calculation results obtained by executing the program 213 for analyzing acceleration synchronism between a teacher and students, the program 214 for analyzing acceleration synchronism among students, the program 215 for calculating an indicator of face-to-face communication, and the program 216 for analyzing correlation between scholastic performance data and a human behavior indicator in the analysis program suite 212 are visually displayed on the display device 203 and stored into the hard disk 207.

### <Databases>

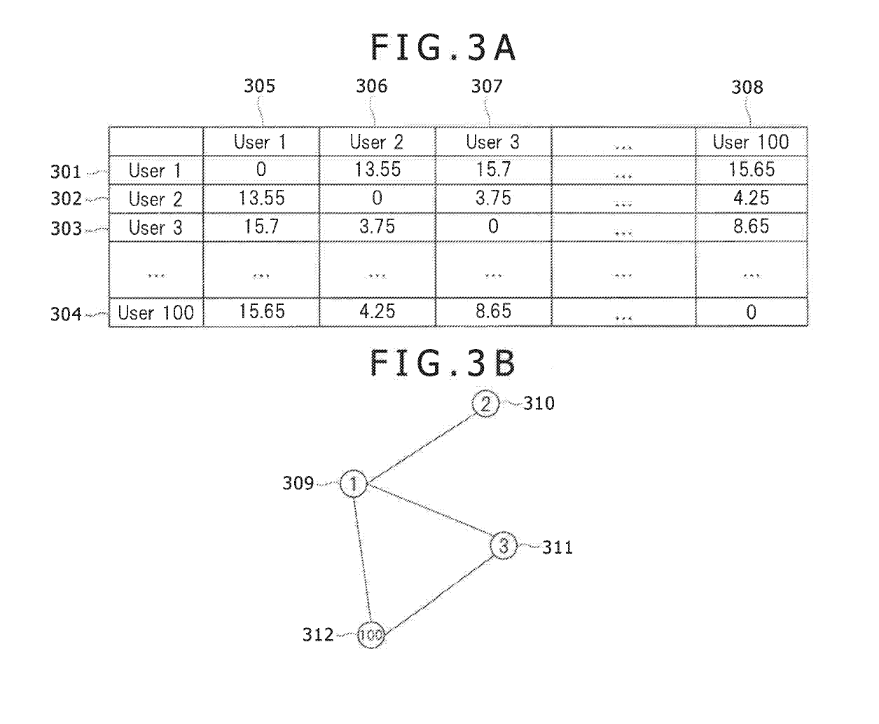

Then, using FIGS. 3 to 5, descriptions are provided about respective databases in the above-described system for presenting a factor correlating with scholastic performance. In the following, the face-to-face information database 209, the acceleration information database 210, and the user attribute database 211 appearing in FIG. 2 are described in order.

### <<Face-to-Face Database>>

FIG. 3A is a diagram presenting an example of a data set which is stored in the face-to-face information database. FIG. 3B is a diagram depicting an example of a face-to-face interaction network. More specifically, FIG. 3A presents an example of a data set concerning face-to-face time information which is interhuman relations graph data which is externally input to the system for presenting a factor correlating with scholastic performance. FIG. 3B depicts an example of a face-to-face interaction network which can be drawn by using data presented in FIG. 3A. The data set concerning face-to-face time information presented in FIG. 3A is to be stored in the face-to-face information database 209 in FIG. 2.

In FIG. 3A, reference numerals 301, 302, 303, 304 respectively denote user IDs of students or a teacher which are serially allocated to rows and reference numerals 305, 306, 307, 308 respectively denote user IDs of students of a teacher which are serially allocated to columns. In FIG. 3B, reference numerals 309, 310, 311, 312 respectively denote the node numbers of nodes representing students or a teacher in the face-to-face interaction network diagram which drew face-to-face relations.

In FIG. 3 B, a link between nodes in the face-to-face interaction network is drawn according to a rule, for example, that a link is to be put between nodes if the nodes (persons) are engaged in face-to-face interaction for five minutes or longer a day.

In FIG. 3A, matrix elements represent face-to-face time of students, a teacher, etc. who are members ina school. The face-to-face time is obtained by, e.g., wearable sensors of a name tag form embedded with an infrared sensor, which have been attached to the students and the teacher, and is described, e.g., in units of minutes.

In FIG. 3A, a method of measuring face-to-face time may be taking measurements using wearable sensors mentioned above or other methods may be used.

In FIG. 3A, there are the corresponding row and column of the same person; for example, User 1 (301) and (305) (the reference numerals of the corresponding row and column are given in parentheses), User 2 (302) and (306), User 3 (303) and (307), and User 100 (304) and (308). Cells where these row and columns cross are filled with 0, because the person face-to-face interacts with himself or herself, namely, zero as this information.

In FIG. 3A, the matrix elements of User 1 (301) and User 2 (306) are 13.55; this indicates that User 1 and User 2 are engaged in face-to-face interaction for, e.g., 13.55 minutes on average a day.

By using the dataset concerning face-to-face time as presented in FIG. 3A, information on how much two persons identified are engaged in face-to-face interaction at school is obtained.

In FIG. 3B, it is possible to draw a network diagram representing relations between persons at school from face-to-face relations. In this case, nodes stand for persons and, by defining a rule, for example, that “a link is to be drawn between nodes for which face-to-face time is five minutes or longer”, a network diagram comprised of nodes and links can be drawn.

In FIG. 3B, by using the rule that “a link is to be drawn between nodes for which face-to-face time is five minutes or longer”, a network diagram is drawn as described below. Because the matrix elements of User 1 (301) and User 2 (306) are 13.55 in FIG. 3A, a link is drawn between node 1 (309) and node 2 (310). Likewise, because the matrix elements of User 1 (301) and User (307) are 15.7, a link is also drawn between node 1 (309) and node 3 (311).

Because the matrix elements of User 2 (302) and User 3 (307) are 3.75 in FIG. 3A, no link is drawn between node 2 (310) and node 3 (311) in FIG. 3B.

In FIG. 3B, likewise, links are drawn between node 100 (312) and node 1 (309) and between node 100 (312) and node 3 (311).

### <<Acceleration Database>>

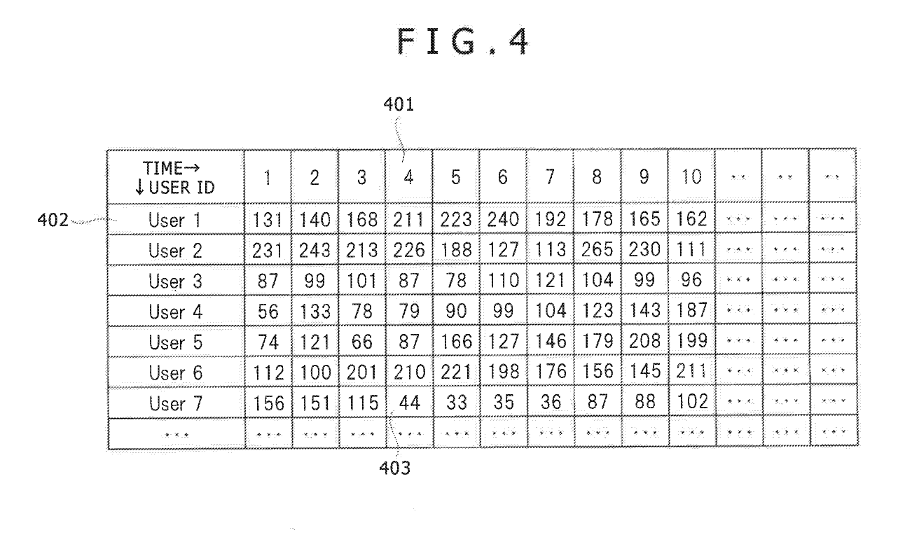

FIG. 4 is a diagram presenting an example of a data set which is stored in the acceleration database. More specifically, FIG. 4 presents an example of a data set concerning acceleration information which is physical movement data which is externally input to the system for presenting a factor correlating with scholastic performance. The data set concerning acceleration information presented in FIG. 4 is to be stored in the acceleration information database 210 in FIG. 2.

In FIG. 4, reference numeral 401 denotes time information described horizontally in a table representing the data set; 402 denotes user IDs of persons who are a teacher or students described vertically; and 403 denotes a value representing a degree of physical movement.

Time 401 is recorded in steps of, e.g., one minute.

User IDs 402 correspond to the user IDs 301 to 308 in FIG. 3.

A value 403 representing a degree of physical movement may be, e.g., the number of vibrations indicating the number of times a person vibrated per minute, a value which is expressed by Hz, i.e., the number of vibrations per second, or any other value indicating activity or frequency of physical movement. For example, if the number of vibrations per minute is adopted; in the example of FIG. 4, a student identified by User 1 as User ID 402 is assigned a value of 131 as the value 401 for one minute (between 0 and one minute) as the time 401, which indicates that the student vibrated 131 times for this one minute.

### <<User Attribute Database>>

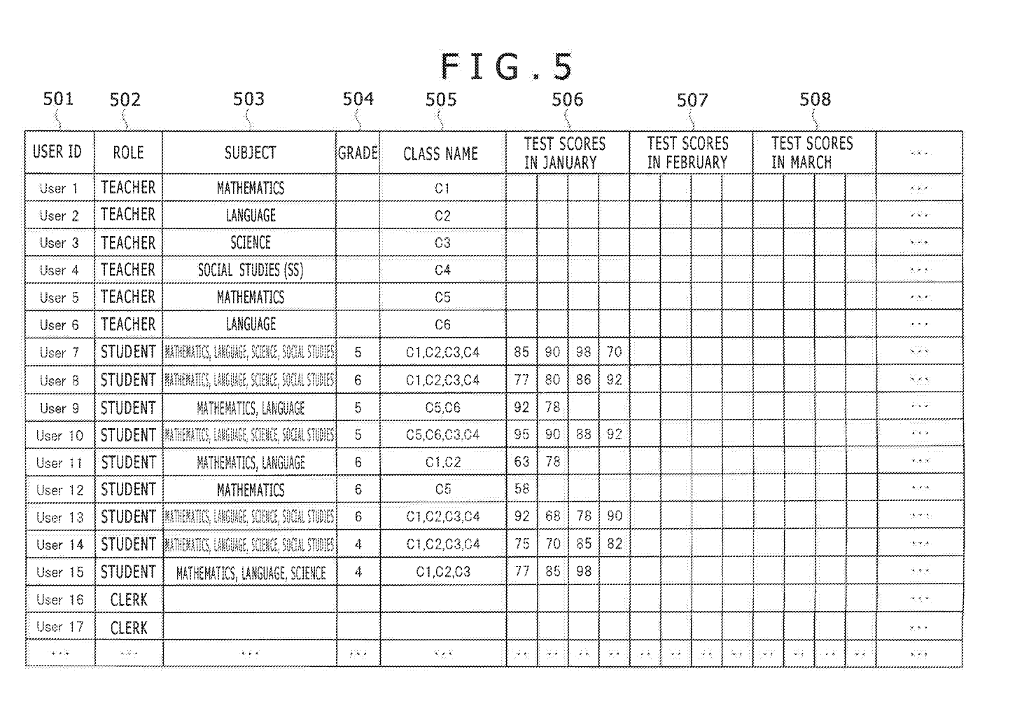

FIG. 5 is a diagram presenting an example of a data set which is stored in the user attribute database. The data set concerning user attributes presented in FIG. 5 is to be stored in the user attribute database 211 in FIG. 2.

In FIG. 5, reference numeral 501 denotes a user ID field for the user IDs of students, teachers, etc.; 502 denotes a role field which represents differentiation in roles such as a teacher, student, and clerk; 503 denotes a subject field for which a teacher is responsible and students attend a class; 504 denotes a grade field; 505 denotes a class name field for a class for which a teacher is responsible and which students attend; and 506, 507, 508 denote the fields of test scores which reflect scholastic performance.

User IDs in the user ID field 501 correspond to the user IDs 301 to 308 and 402 which are recorded in the face-to-face information database 209 and the acceleration information database 210.

The role field 502 is to differentiate teachers, students, and other school staff such as clerks.

In the subject field 503, the following are recorded: the name of a subject for which a person who is a teacher in the role field 502 is responsible, the name of a subject for which a person who is a student in the role field 502 attends a class, and the names of plural subjects, if a teacher is responsible for plural subjects or a student attends the classes of plural subjects. In the example of FIG. 5, recorded are mathematics, language, science, and social studies.

In the grade field 504, the grade of a person whose role is a student is recorded. In the example of FIG. 5, recorded are fifth, sixth and fourth grades.

A class name in the class name field 505 is a unique identifier assigned to each subject in the subject field 503. For a person (user) who is a teacher in the role field 502, the class ID of a subject for which the person is responsible is written in this field. For a person (user) who is a student in the role field 502, the class ID of a subject for which the person attends a class is written in this field. In the example of FIG. 5, recorded are classes C1 to C6.

If there are plural subjects in the subject field 503, the corresponding identifiers are recorded in the class name filed 505.

In the field 506 of test scores in January, results of monthly tests performed in January are written.

If a student attends the classes of plural subjects, test results for the plural subjects are written in the field 506 of test scores in January. In the example of FIG. 5, for example, a student, User 7 in the user ID field 501, attends the classes of the subjects of mathematics, language, science, and social studies. Thus, in the field 506 of test scores in January for User 7, scores 85 for mathematics, 90 for language, 98 for science, and 70 for social studies are recorded in this order. A student, User 9 in the user ID field 501, only attends the classes of two subjects of mathematics and language. Thus, in the field 506 of test scores in January for User 9, scores 92 for mathematics and 78 for language are recorded in this order, but no scores for science and social studies are recorded.

The field 507 of test scores in February and the field 508 of test scores in March are used in the same way as the field 506 of test scores in January. After tests are performed and results are scored, test scores are recorded in these fields in the user attribute database 211 which is presented in the example of FIG. 5.

Other attributes, e.g., sexuality, age, etc. besides those given in FIG. 5 may be added to the user attribute database, though not presented in FIG. 5.

### <Analysis of Acceleration Synchronism Between a Teacher and Students>

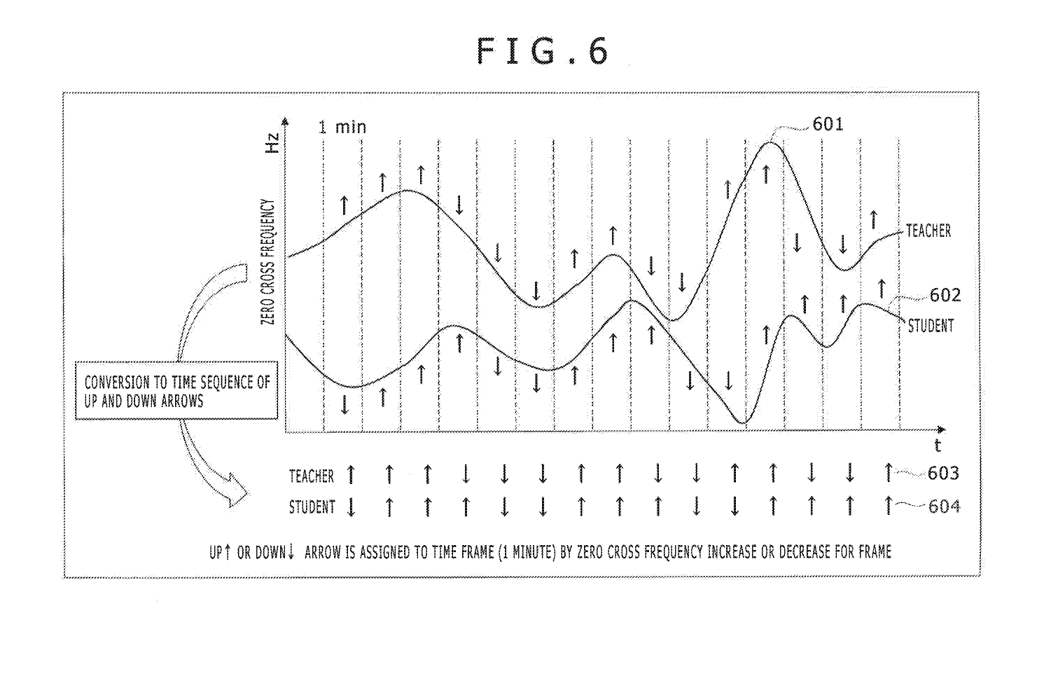

Using FIGS. 6 to 8, descriptions are provided about an analysis of acceleration synchronism between a teacher and students, which is referred to previously. In the following, acceleration waveform 1, flowchart 1, and experiment result 1 are described in order.

### <<Acceleration Waveform 1>>

FIG. 6 is a diagram presenting an example of the acceleration waveforms of a teacher and a student and converting them to a notation using arrows. The acceleration waveforms of a teacher and a student in FIG. 6 represent an example of physical movement data.

In FIG. 6, reference numeral 601 denotes the acceleration waveform of a teacher; 602 denotes the acceleration waveform of a student; 603 denotes a time sequence of up and down arrows to which the teacher's acceleration waveform is converted; and 604 denotes a time sequence of up and down arrows to which the student's acceleration waveform is converted.

The teacher's acceleration waveform 601 and the student's acceleration waveform 602 are those obtained by sequencing in time series the number of vibrations per unit time which is obtained from acceleration sensors embedded in, e.g., wearable sensors of a name tag form which teachers and students wear, i.e., those obtained by sequencing in times series numeric data 403 (FIG. 4) stored in the acceleration information database 210 in FIG. 2. Data may be used which is obtained from acceleration sensors or the like embedded in, e.g., mobile phones instead of wearable sensors.

The time sequence 603 of up and down arrows to which the teacher's acceleration waveform is converted and the time sequence 604 of up and down arrows to which the student's acceleration waveform is converted are obtained in a way as described below.

First, for each given time frame, e.g., one minute, numeric data 403 representing a degree of physical movement, e.g., a zero-cross frequency of acceleration, for the current frame is compared with the numeric data for the preceding frame.

Then, if the zero-cross frequency of acceleration for the current frame is larger than that for the preceding frame, an up arrow is assigned to the current frame. That is, if the zero-cross frequency increases for the current frame, an up arrow “↑” is assigned to the current frame. If the zero-cross frequency of acceleration for the current frame is smaller than that for the preceding frame, a down arrow is assigned to the current frame. That is, the zero-cross frequency decreases for the current frame, a down arrow “↓” is assigned to the current frame.

Rules other than the above-described one may be used for a way of conversion to arrows. Instead of two values of up and down arrows, any other value that represents fluctuation per time frame may be used.

The following describes a method of evaluating correlation of physical movement synchronism between a teacher and students with scholastic performance through the use of the time sequence 603 of up and down arrows to which the teacher's acceleration waveform is converted and the time sequence 604 of up and down arrows to which the student's acceleration waveform is converted presented in FIG. 6.

In terms of student movement fluctuation relative to teacher movement fluctuation, there are four patterns as follows: “teacher is ↑ and student is ↑”, “teacher is ↑ and student is ↓”, “teacher is ↓ and student is ↑”, and “teacher is ↓ and student is ↓”.

Using Equation (1), calculations are made of percentages Pᵢⱼ of occurrence of each of these patterns in which each student behaves relative to teacher movement for a certain period, e.g., one month.

$$\begin{matrix}[ Equation 1 ] & \\ {P}_{ij} = \frac{Time ( in minutes ) for which teacher is i and student is j}{Total school time ( in minutes )} , \\ i , j \\ is \\ ↑ or ↓ & ( 1 )\end{matrix}$$

Here, total school time is the sum of school hours when the student attended a class for a certain period, e.g., one month.

For example, “a percentage of a pattern in which a teacher is active and a student is quiet” is expressed by P_{↓↑}.

For each student, the percentages Pᵢⱼ of the four patterns are calculated by Equation 1. By calculating the correlations of the percentages Pᵢⱼ with the student's scholastic performance, e.g., test scores stored in the field 506 of test scores in January in the user attribute database 211 in FIG. 5, it is possible to know which pattern in which a teacher and a student physically interact with each other in class has a good effect on scholastic performance.

### <<Flowchart 1>>

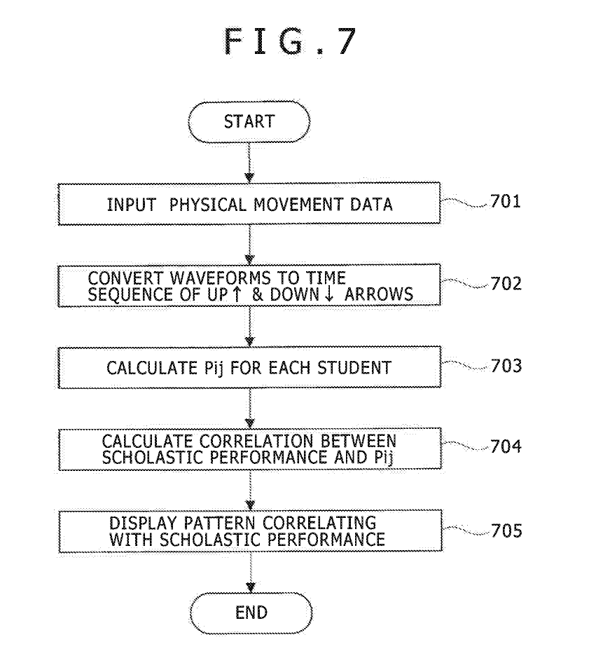

FIG. 7 is a flowchart illustrating an example of a process of analyzing correlation between physical movement synchronism between a teacher and students and scholastic performance.

In FIG. 7, reference numeral 701 denotes a step of inputting physical movement data; 702 denotes a step of converting acceleration waveforms to a time sequence of up and down arrows; 703 denotes a step of calculating percentages Pᵢⱼ as per Equation (1) for each student; 704 denotes a step of calculating correlations between scholastic performance and the percentages Pᵢⱼ; and 705 denotes a step of displaying a result of correlation analysis, i.e., displaying a pattern correlating with scholastic performance on a display or the like of the display device 203.

The process with steps 701 to 705 is performed as follows: information on acceleration stored in the acceleration information database 210 in FIG. 2 is read and loaded into the memory 208; and the CPU 206 executes the program 213 for analyzing acceleration synchronism between a teacher and students. Thereby, the steps from 701 to 705 are executed in order.

The step 701 of inputting physical movement data is to input physical movement data which is obtained from acceleration sensors embedded in, e.g., wearable sensors of a name tag form which teachers and students wear or mobile phones to the system. If physical movement data has already been stored in the acceleration information database 210 in FIG. 2, there is no need to input such data again.

The step 702 of converting acceleration waveforms to a time sequence of up and down arrows is as follows. Numeric data 403 (FIG. 4) stored in the acceleration information database 210 in FIG. 2 is read and loaded into the memory 208. For each given time frame, e.g., one minute, numeric data 403 representing a degree of physical movement, the zero-cross frequency of acceleration which is used here, for the current frame is compared with that for the preceding frame. Then, if the zero-cross frequency of acceleration for the current frame is larger than that for the preceding frame, an up arrow is assigned to the current frame. If the zero-cross frequency of acceleration for the current frame is smaller than that for the preceding frame, a down arrow is assigned to the current frame.

The step 703 of calculating percentages Pᵢⱼ for each student is to evaluate Equation (1) for each student.

The step 704 of calculating correlations between scholastic performance and the percentages Pᵢⱼ is to evaluate which of the percentages Pᵢⱼ of the four patterns calculated for each student for a certain period correlates with the student's scholastic performance such as, e.g. test scores in the fields 506, 507, and 508.

The step 705 of displaying a pattern correlating with scholastic performance is to display which pattern correlates with scholastic performance as the result of evaluating the correlations between scholastic performance and the percentages Pᵢⱼ on the display or the like.

### <<Experiment Result 1>>

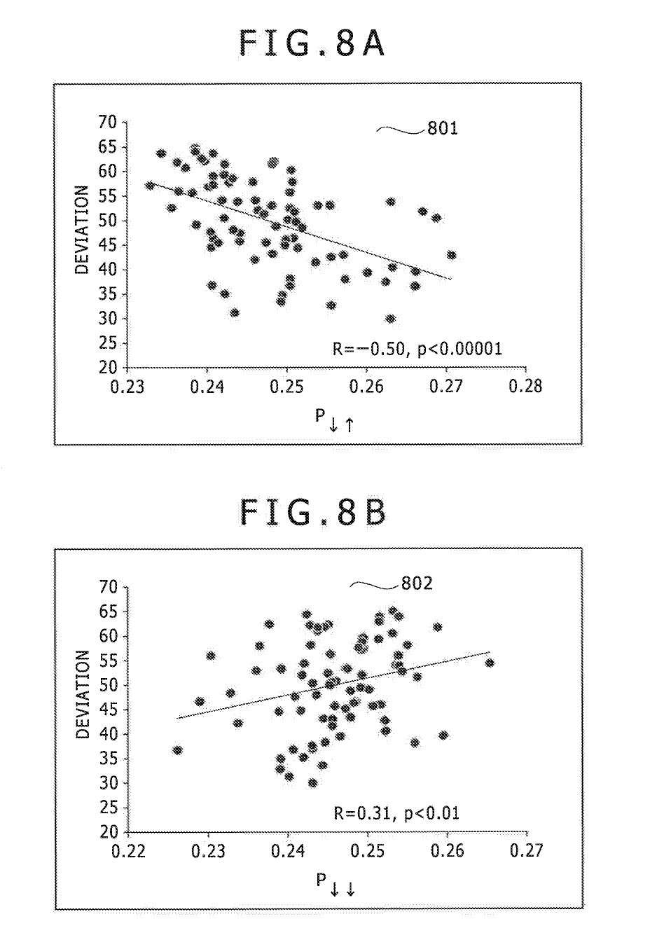

FIGS. 8A and 8B are scatter diagrams presenting examples of results of an experiment in which an evaluation is made of correlations between the patterns of physical movement synchronism between a teacher and students and scholastic performance. More specifically, FIGS. 8A and 8B present results of calculations made of the correlations between the percentages Pᵢⱼ of the four patterns, which are calculated by Equation (I), and the performance of an individual student (an average of deviation of monthly test scores of all subjects for which the student attend a class for three months). These calculations are made with data for 82 students of the fifth and sixth grades.

In FIG. 8A, reference numeral 801 denotes a result of an experiment in which an evaluation is made of correlation between the percentage Pit and student performance. In FIG. 8B, reference numeral 802 denotes a result of an experiment in which an evaluation is made of correlation between the percentage P_{↓↓} and student performance. In FIGS. 8A and 8B, the scholastic performance of an individual student is here expressed by deviation which is plotted on the ordinate and the percentage P_{↓↑} and the percentage P_{↓↓} are plotted on the abscissa. Points denote 82 students respectively. In each diagram, a correlation coefficient R and a p value which indicates statistical significance are specified.

The diagrams in FIGS. 8A and 8B indicate that there are significant correlations of P_{↓↑} and P_{↓↓} with the deviations which express the scholastic performances of individual students; P_{↓↑} has a correlation coefficient R=−0.50 (p<0.00001) 801 and P_{↓↓} has a correlation coefficient R=0.31(p<0.01) 802. In FIG. 8A, there is a proportional relation (negatively sloped correlation) in which the deviation level decreases, as P_{↓↑} increases. In FIG. 8B, there is a proportional relation (positively sloped correlation) in which the deviation level increases, as P_{↓↓} increases. This indicates the following: “students who become active when a teacher becomes quiet have poor performance”; conversely, “students who become quiet when a teacher becomes quiet have good performance”. This result can be interpreted as follows: when a teacher calls attention quietly, students who are noisy have poor performance and students who stop moving and pay attention to teacher's speech and behavior have good performance.

### <Analysis of Acceleration Synchronism Among Students>

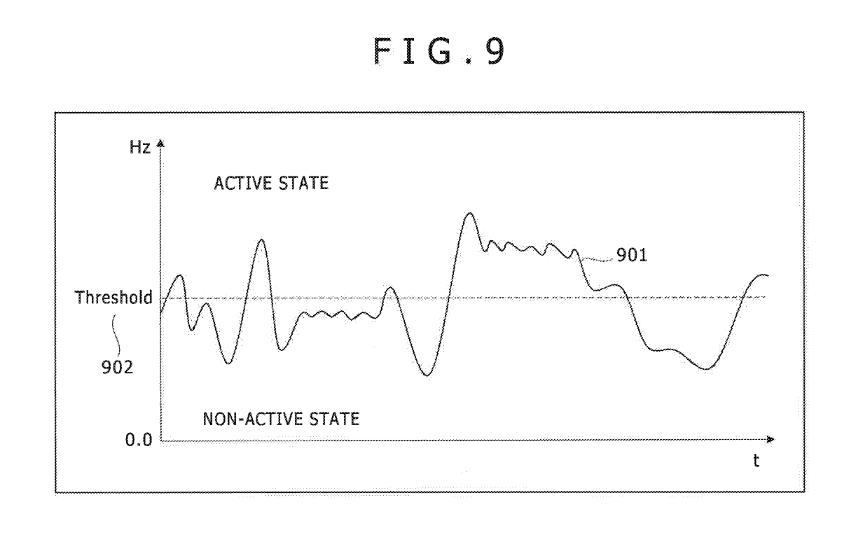

Using FIGS. 9 to 11, then, descriptions are provided about an analysis of acceleration synchronism among students, which is referred to previously. In the following, acceleration waveform 2, flowchart 2, and experiment result 2 are described in order.

### <<Acceleration Waveform 2>>

FIG. 9 is a diagram presenting an example of separating an acceleration waveform among students into active and non-active states. The acceleration waveform among students in FIG. 9 represents an example of physical movement data.

In FIG. 9, reference numeral 901 denotes an acceleration waveform and 902 denotes a threshold of acceleration.

The acceleration waveform 901 is that obtained by sequencing in time series the number of vibrations per unit time which is obtained from acceleration sensors embedded in, e.g., wearable sensors of a name tag form which students wear, i.e., that obtained by sequencing in times series numeric data 403 (FIG. 4) stored in the acceleration information database 210 in FIG. 2. Data may be used which is obtained from acceleration sensors or the like embedded in, e.g., mobile phones instead of wearable sensors.

The threshold 902 of acceleration is, e.g., a zero-cross frequency of an average acceleration among all students and a value for separating physical movement into dynamic movement such as running and talking with gestures and static movement such as writing nodes while sitting on a chair.

A time frame, e.g., every one minute, for which the number of vibrations is larger than the threshold 902 of acceleration can be judged as the active state and a time frame for which the number of vibrations is smaller than the threshold 902 of acceleration can be judged as the non-active state.

Through the use of the active and non-active states presented in FIG. 9, an indicator U of physical movement synchronism among students in each class is defined as expressed in Equation (2); the indicator U is referred to as a degree of unity herein.

$$\begin{matrix}[ Equation 2 ] & \\ U = \frac{1}{T} {\sum }_{i = 1}^{T} [ \frac{max ( {n}_{Active}^{′} , {n}_{Non - Active}^{′} )}{N} ] & ( 2 )\end{matrix}$$

Here, T is total school time for a certain period, n^{t}_{Active} is the number of students in a class judged as active at time t, n^{t}_{Non-active} is the number of students in a class judged as non-active at time t, N is the total number of students in a class, and max(a, b) is a function that takes the value of a or b which is larger. For example, in the case of a class comprised of 10 students, if six students are judged as active at time t and four students are judged as non-active at time t, then, n^{t}_{Active}=6 and n^{t}_{Non-active}=4 and the term in brackets in Equation 2 is calculated as below: max (n^{t}_{Active}, n^{t}_{Non-active})/N=max (6,4)/10=0.6. A value obtained by calculating the term in brackets in Equation (2) for each time frame and averaging result values over the total time indicates how the students' states coincide per time frame and is defined as a degree of physical movement synchronism among the students in the class, namely, a degree of unity.

A degree of unity U assumes a value ranging from 0.5 to 1.0 and a larger value indicates that class members make similar physical movement. Conversely, a smaller value means that some students move actively, whereas other students little move; i.e., there is variation in physical movement of class members.

### <<Flowchart 2>>

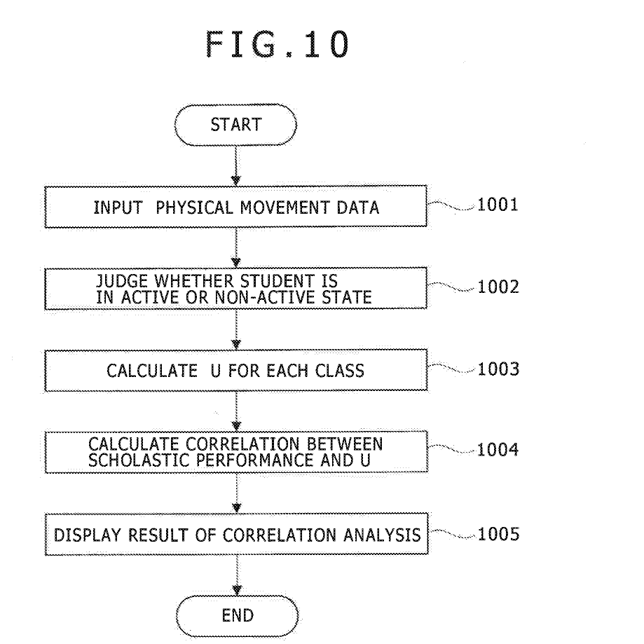

FIG. 10 is a flowchart illustrating an example of a process of analyzing correlation between physical movement synchronism among students and scholastic performance. More specifically, FIG. 10 is a flowchart for evaluating a relation between a class's scholastic performance, i.e., an average of scholastic performances of class members, and physical movement synchronism among students in the class by using a degree of unity U.

In FIG. 10, reference numeral 1001 denotes a step of inputting physical movement data; 1002 denotes a step of judging whether a student is in active or non-active state for each of students who constitute a class; 1003 denotes a step of calculating a degree of unity U as per Equation (2) for each class; 1004 denotes a step of calculating correlation between scholastic performance (an average of scholastic performances of students who constitute the class) and the degree of unity U; and 1005 denotes a step of displaying a result of correlation analysis on a display or the like.

The process with steps 1001 to 1005 is performed as follows: information on acceleration stored in the acceleration information database 210 in FIG. 2 is read and loaded into the memory 208; and the CPU 206 executes the program 214 for analyzing acceleration synchronism among students. Thereby, the steps from 1001 to 1005 are executed in order.

The step 1001 of inputting physical movement data is to input physical movement data which is obtained from acceleration sensors embedded in, e.g., wearable sensors of a name tag form which teachers and students wear or mobile phones to the system. If physical movement data has already been stored in the acceleration information database 210 in FIG. 2, there is no need to input such data again.

The step 1002 of judging whether a student is in active or non-active state for each of students who constitute a class is as follows. Numeric data 403 (FIG. 4) stored in the acceleration information database 210 in FIG. 2 is read and loaded into the memory 208. For each given time frame, e.g., one minute, first, it is evaluated whether the numeric data 403, e.g., a value of the zero-cross frequency of acceleration is higher or lower than the threshold for each of students who constitute the class. If the value is higher than the threshold, the student is judged as being in the active state. If the value is lower than the threshold, the student is judged as being in the non-active state.

The step 1003 of calculating a degree of unity U for each class is to evaluate Equation E for each class.

The step 1004 of calculating correlation between scholastic performance (an average of scholastic performances of students who constitute the class) and the degree of unity U is to evaluate how U per class correlates with scholastic performance per class (an average of the test scores of the students in the class).

The step 1005 of displaying a result of correlation analysis is to display a result of evaluating correlation between scholastic performance and the degree of unity U on a display or the like of the display device 203.

### <<Experiment Result 2>>

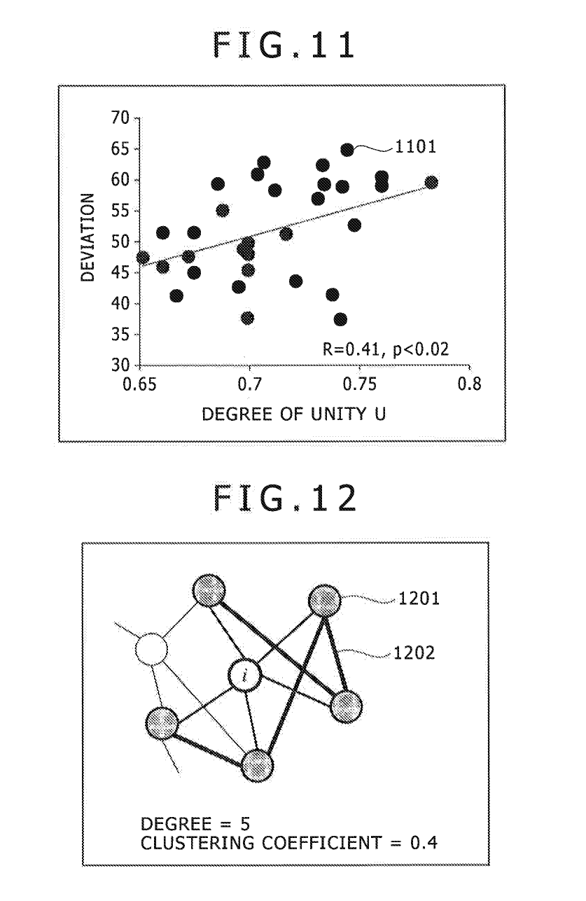

FIG. 11 is a scatter diagram presenting an example of a result of an experiment in which an evaluation is made of correlation between a degree of unity of physical movement among students who constitute a class and the class's scholastic performance. More specifically, for 31 classes of the fifth and sixth grades, a degree of unity U for each class is calculated and it is evaluated how the degree of unity U correlates with the class's deviation value (an average of the deviations of students belonging to the class); the result is presented in FIG. 11.

In FIG. 11, reference numeral 1101 denotes the result of the experiment in which an evaluation is made of correlation between a degree of unity U of each class and the class's deviation value. The degree of unity U per class calculated by Equation (2) for a certain period is plotted on the ordinate and deviation values per class (an average of the deviations of students who constitute the class) are plotted on the abscissa. Points denote 31 classes respectively.

The diagram in FIG. 11 indicates that there is a correlation in which a class whose degree of unity U is higher has a higher deviation value (R=0.41, p<0.02). In FIG. 11, there is a proportional relation (positively sloped correlation) in which the deviation value increases, as the degree of unity U increases. This means that a class having good performance is the class in which students make similar movement in a physically uniform manner, e.g., all students become quiet when they should do so and all behave actively when they should do so in class. Conversely, what is a class with a small degree of unity and having poor performance is as follows: a class in which some students ask a question to a teacher or turn around and talk to someone in a backward position during a time zone when all students have to solve problems and note answers or a class in which some students hardly speak up or do not move much throughout school hours.

### <Analysis of Face-to-Face Communication>

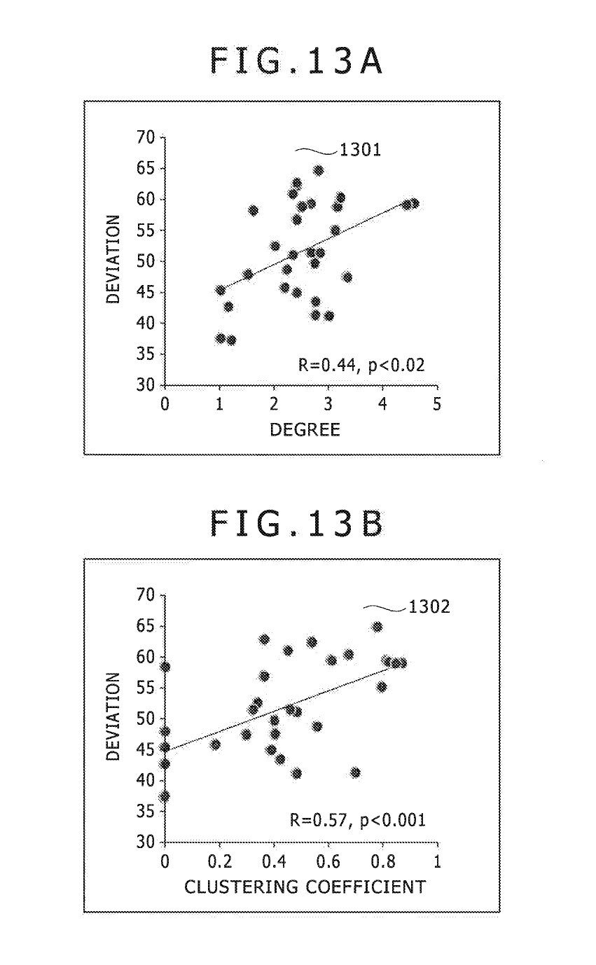

Using FIGS. 12 to 14, then, descriptions are provided about an analysis of face-to-face communication, which is referred to previously. In the following, a face-to-face interaction network, experiment result 3, experiment result 4, and flowchart 3 are described in order.

### <<Face-to-Face Interaction Network>>

FIG. 12 is a diagram depicting an example of a face-to-face interaction network drawn using face-to-face information. More specifically, FIG. 12 represents an aspect of face-to-face interaction between persons such as students and teachers at school in the network diagram.

In FIG. 12, reference numeral 1201 denotes a node standing for a person and 1202 denotes a link which is drawn according to a rule that a link is to be drawn between nodes (persons), if they are engaged in face-to-face interaction for a certain amount of time or longer.

Face-to-face information on school or tutoring school members such as students and teachers is face-to-face information per user stored in the face-to-face information database 209 in FIG. 2.

Using FIG. 12, a degree and a clustering coefficient which characterize face-to-face communication are described.

The degree of node i is the number of links connected to the node i and the degree of i is 5 in the example of FIG. 12. This means that person i is engaged in face-to-face interaction with five persons for a certain amount of time or longer.

The clustering coefficient C: of node i is defined by Equation (3).

$$\begin{matrix}[ Equation 3 ] & \\ {C}_{i} = \frac{2 {e}_{i}}{{k}_{i} ( {k}_{i} - 1 )} & ( 3 )\end{matrix}$$

Here, kᵢ is the number of nodes connected to node i, namely, a degree and eᵢ is the number of links connecting the nodes.

In the example of FIG. 12, kᵢ=5 and eᵢ=4; hence, Cᵢ=2×4/5×4=0.4.

Larger degree and clustering coefficient mean that person i is engaged in face-to-face interaction with a larger number of persons around him or her and actively communicates with them.

Calculating an indicator reflecting a face-to-face interaction aspect, such as a degree and a clustering coefficient, is performed as follows: face-to-face time information per user stored in the face-to-face information database 209 in FIG. 2 is read and loaded into the memory 208 and the CPU 206 executes the program 215 for calculating an indicator of face-to-face communication in the analysis program suite 212.

### <<Experiment Result 3>>

Experiment result 3 is a result of an experiment in which an evaluation is made of correlation between scholastic performance of an individual student and face-to-face communication. Calculations are executed on correlation between the test scores of 82 students of the fifth and sixth grades and the number of persons (face-to-face persons) with whom each student face-to-face communicated at break, i.e., the degree in the face-to-face interaction network. The result indicates that there is a tendency of correlation between both (R=0.22, p<0.051). That is, the following tendency is found: a student who face-to-face communicates with more persons such as other students and a teacher at break has better performance than a student who spends time alone at break.

### <<Experiment Result 4>>

Experiment result 4 is a result of an experiment in which an evaluation is made of correlation between scholastic performance per class and face-to-face communication. The degree per class is that obtained by averaging the orders kᵢ of individual students who constitute a class by all members constituting the class. Likewise, the clustering coefficient per class is calculated as that obtained by averaging the clustering coefficients Cᵢ of individual students by all members constituting the class.

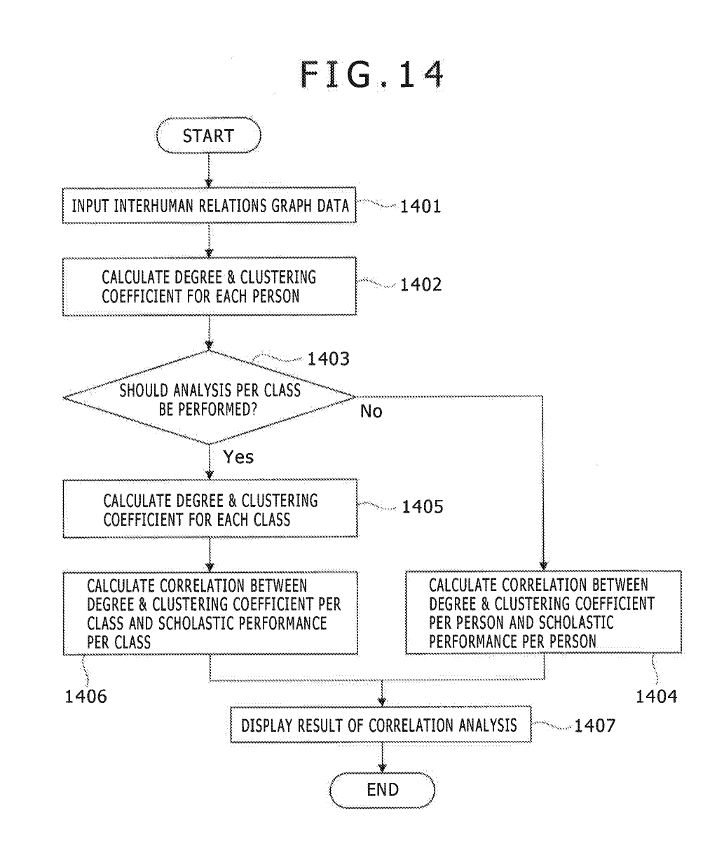

FIGS. 13A and 13B are scatter diagrams presenting examples of results of an experiment in which an evaluation is made of correlation between indicators in the face-to-face interaction network of students and a teacher constituting a class and the class's scholastic performance. More specifically, the degree and the clustering coefficient per class are calculated using information on face-to face communication at break and their correlations with scholastic performance per class are presented in FIGS. 13A and 13B.

In FIG. 13A, reference numeral 1301 denotes an experiment result which represents correlation between the degrees of classes and the classes' deviation values. In FIG. 13B, reference numeral 1302 denotes an experiment result which represents correlation between the clustering coefficients of classes and the classes' deviation values.

The experiment result 1301 in FIG. 13A indicates that the degrees of classes correlate with the classes' deviation values (R=0.44, p<0.02). In FIG. 13A, there is a proportional relation (positively sloped correlation) in which the deviation value increases, as the degree increases.

Also, the experiment result 1302 in FIG. 13B indicates that the clustering coefficients of classes also correlate with the classes' deviation values (R=0.57, p<0.001). In FIG. 13B, there is a proportional relation (positively sloped correlation) in which the deviation value increases, as the clustering coefficient increases.

This result indicates that a class that is united as a group, in which students tend to get in close face-to-face communication at break, has good performance.

### <<Flowchart 3>>

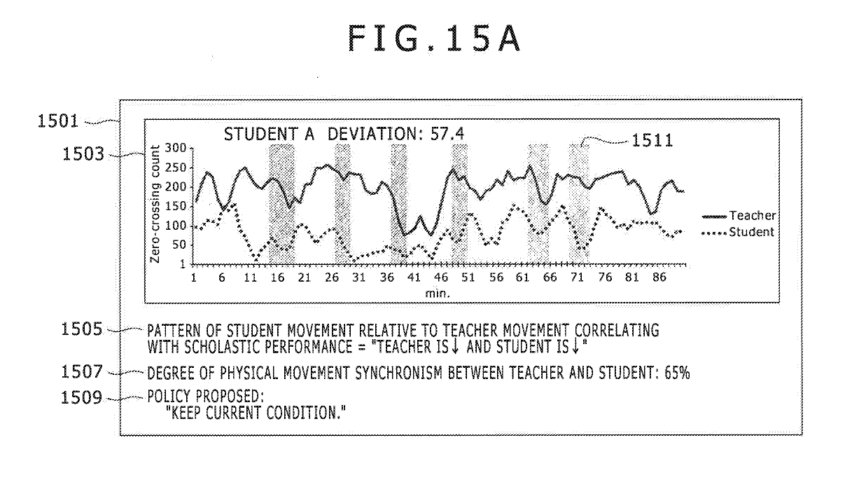

FIG. 14 is a flowchart illustration an example of a process of analyzing correlation between an indicator of face-to-face communication and scholastic performance. More specifically, FIG. 14 is a flowchart for evaluating correlation between an indicator in the face-to-face interaction network, such as, namely, a degree and a clustering coefficient, and scholastic performance.

In FIG. 14, reference numeral 1401 denotes a step of inputting interhuman relations graph data; 1402 denotes a step of calculating a degree and clustering coefficient, which are indicators in the face-to-face interaction network, for each person; 1403 denotes a step of determining whether analysis per class should be performed; 1404 denotes a step of calculating correlation between the degree and clustering coefficient per person and scholastic performance per person; 1405 denotes a step of calculating a degree and clustering coefficient for each class; 1406 denotes a step of correlation between the degree and clustering coefficient per class and scholastic performance per class; and 1407 denotes a step of displaying a result of correlation analysis.

The process with steps 1401 to 1407 is performed as follows: information on face-to-face interaction stored in the face-to-face information database 209 in FIG. 2 is read and loaded into the memory 208; and the CPU 206 executes the program 215 for calculating an indicator of face-to-face communication. Thereby, the steps from 1401 to 1407 are executed in order.

The step 1401 of inputting interhuman relations graph data is to input such data by reading face-to-face information which is obtained from infrared sensors embedded in wearable sensors which students and teachers or similar articles from the face-to-face information database 209.

The step 1402 of calculating the indicators in the face-to-face interaction network for each person is to calculate the degree and clustering coefficient or any other indicator for each person, i.e., each student or each teacher or each of other users, as explained previously.

The step 1403 of determining whether analysis per class should be performed is to determine whether analysis per class (Yes) or per person (No) should be performed.

As a result of the determination at step 1403, if analysis per class is to be performed (Yes), from the calculated values of the indicators in the network for each person (the calculated values of the degree and clustering coefficient per person) at step 1402, calculating the indicators averaged among the students in a class (the degree and clustering coefficient per class) is first executed (step 1405). Calculating correlation between these class's average indictors and scholastic performance per class (an average of the performances of the students who constitute the class) is executed (step 1406).

As a result of the determination at step 1403, if analysis per person is to be performed (No), using the calculated values of the indicators in the network for each person (the calculated values of the degree and clustering coefficient per person) at step 1402, calculating correlation between each of those values and scholastic performance per person is executed (step 1404).

The step 1407 of displaying a result of correlation analysis is to display a result of evaluation on correlation between the indicators in the face-to-face interaction network per class or person and scholastic performance on a display or the like of the display device 203.

### <Examples of Displaying Analysis Results>

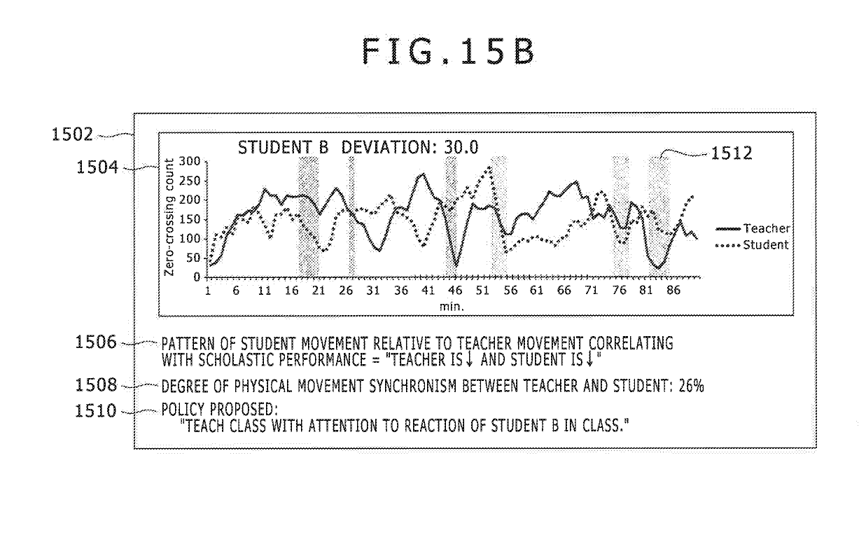

Using FIGS. 15 to 17, then, descriptions are provided about examples of displaying results of analysis processes described previously. In the following, examples of displaying a result of analyzing acceleration synchronism between a student and a teacher, a result of analyzing acceleration synchronism among students, and a result of analyzing face-to-face communication are described in order. These analysis results are displayed on a display or the like of the display device 203.

### <<Result of Analyzing Acceleration Synchronism Between a Student and a Teacher>>

FIGS. 15A and 15B are diagrams presenting examples of screens displaying results of analyzing correlation between physical movement synchronism between a teacher and students and scholastic performance.

In FIG. 15A, reference numeral 1501 denotes an analysis result display screen which displays a relation between a student (student A) having good performance and a teacher. In FIG. 15B, reference numeral 1502 denotes an analysis result display screen which displays a relation between a student (student B) having poor performance and a teacher. In FIGS. 15A and 15B, reference numerals 1503 and 1504 denote teacher and student's acceleration waveforms being displayed; 1505 and 1506 denote a pattern of student movement relative to teacher movement correlating with student's scholastic performance being displayed; 1507 and 1508 denote a degree of physical movement synchronism between teacher and student being displayed; 1509 and 1510 denote a proposed policy message for assisting in practical policy design for improving scholastic performance; and 1511 and 1512 denote highlighted portions characteristic of a pattern of synchronism between teacher and student correlating with scholastic performance.

Although the screens intended for teachers are presented in FIGS. 15A and 15B, the screens may be those intended for students or their parents.

Information being displayed, as presented in FIGS. 15A and 15B, may be displayed on a personal computer's display which is the display device 203 or printed on paper and offered as a report.

The teacher and student's acceleration waveforms 1503 and 1504 being displayed are numeric data 403 being displayed that is relevant to the teacher and student of interest for a certain period retrieved out of data stored in the acceleration information database 210.

In the teacher and student's acceleration waveforms 1503 and 1504, portions characteristic of a distinctive pattern which correlates with scholastic performance, appearing in the teacher and student's waveforms, are highlighted by hatching or the like (highlighted portions 1511 and 1512). In the examples of FIGS. 15A and 15B, portions where both the teacher and student's acceleration waveforms decrease are hatched, based on an experiment result indicating that P_{↓↓}, one of the indicators calculated by Equation (1), correlates with scholastic performance of an individual.

For the pattern of student movement relative to teacher movement correlating with student's scholastic performance being displays 1505 and 1506, one of the four patters calculated by Equation (2) that correlates with scholastic performance of an individual student is expressed. In the examples of FIGS. 15A and 15B, this is described as “teacher is ↓ and student is ↓”, because P_{↓↓} correlates with scholastic performance.

The degree of physical movement synchronism between teacher and student being displayed 1507 and 1508 indicates a percentage by which the pattern of synchronism between student and teacher correlating with scholastic performance has occurred for a certain period. The examples of FIGS. 15A and 15B indicate the following: the percentage P_{↓↓} of the amount of time when “the student becomes quite when the teacher becomes quiet” in the (total) school time is 65% (1507) for a student having good performance, whereas, this percentage is only 26% (1508) for a student having poor performance.

For the proposed policy message 1509 and 1510, a policy proposed is written which should be taken for improving scholastic performance, depending on a difference in the degree of physical movement synchronism between teacher and student. In the examples of FIGS. 15A and 15B, the proposed policy is “Keep current condition” (1509) in the case where the degree of synchronism is high and “Teach a class with attention to reaction of student B in class” (1510) in the case where the degree of synchronism is low. Wording other than the above may be used.

Although the examples of feedback screens intended for teachers are presented in FIGS. 15A and 15B, in the case of feeding back an analysis result to students, the proposed policy message 1510 may become as follows: for example, “Pay more attention to teacher's speech and behavior” for a student having poor performance with a low degree of physical movement synchronism between teacher and student.

Displaying the screens as presented in FIGS. 15A and 15B is performed in the step (705) of displaying a pattern correlating with scholastic performance in the flowchart presented in FIG. 7.

### <<Result of Analyzing Acceleration Synchronism Among Students>>

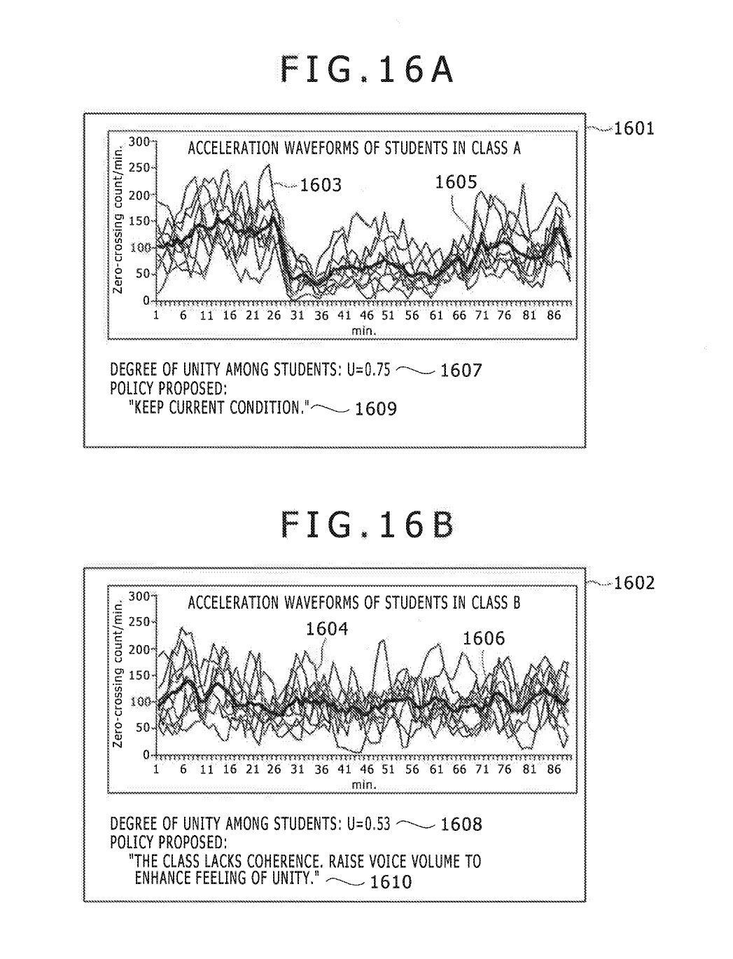

FIGS. 16A and 16B are diagrams presenting examples of screens displaying results of analyzing correlation between physical movement synchronism among students and scholastic performance.

In FIG. 16A, reference numeral 1601 denotes an analysis result display screen which displays a relation between a degree of physical movement synchronism among students in a class (class A) having good performance and the class's scholastic performance. In FIG. 16B, reference numeral 1602 denotes an analysis result display screen which displays a relation between a degree of physical movement synchronism among students in a class (class B) having poor performance and the class's scholastic performance. In FIGS. 16A and 16B, reference numerals 1603 and 1604 denote the acceleration waveforms of students who constitute the class being displayed; 1605 and 1606 denote average acceleration waveforms among the students who constitute the class being displayed; 1607 and 1067 denote a degree of unity among the students in the class being displayed; and 1609 and 1610 denote a proposed policy message for assisting in policy design for improving the class's scholastic performance.

Although the screens intended for teachers are presented in FIGS. 16A and 16B, the screens may be those intended for students or their parents.

Information being displayed, as presented in FIGS. 16A and 16B, may be displayed on a personal computer's display which is the display device 203 or printed on paper and offered as a report.

The acceleration waveforms of students who constitute the class being displayed 1603 and 1604 are data for a certain period, which is being displayed, retrieved out of numeric data 403 stored in the acceleration information database 210.

The average acceleration waveforms among the students who constitute the class being displayed 1605 and 1606 are calculated using numeric data 403 representing physical movement per time frame for each student.

For the degree of unity among the students in the class being displayed 1607 and 1608, a value calculated by the calculation formula given in Equation (2) is displayed.

For the proposed policy message 1609 and 1610, a policy proposed is written which should be taken for improving scholastic performance, depending on a difference in the degree of physical movement synchronism among students. In the examples of FIGS. 16A and 16B, the proposed policy is “Keep current condition” (1609) in the case where the degree of unity is high and “the class lacks coherence; Raise voice volume to enhance the feeling of unity” (1610) in the case where the degree of unity is low. Wording other than the above may be used.

Although the examples of feedback screens intended for teachers are presented in FIGS. 16A and 16B, in the case of feeding back an analysis result to students, the proposed policy message 1610 may become as follows: for example, “Participate in class more cooperatively with classmates” for a student belonging to a class whose average scholastic performance is poor.

### <<Result of Analyzing Face-to-Face Communication>>

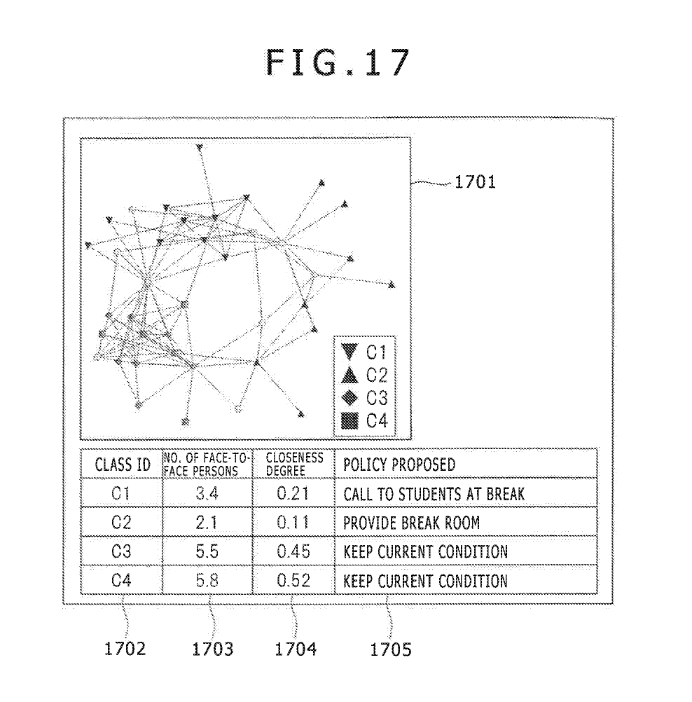

FIG. 17 is a diagram presenting an example of a screen displaying a result of analyzing correlation between an indicator of face-to-face communication and scholastic performance.

In FIG. 17, reference numeral 1701 denotes a face-to-face interaction network diagram; 1702 denotes a class ID field; 1703 denotes a field for degrees per class; 1704 denotes a field for clustering coefficients per class; and 1705 denotes a field for a proposed policy message for improving scholastic performance per class.

The face-to-face interaction network diagram 1701 displays an aspect of face-to-face interaction for a certain period, obtained using the face-to-face information database 209, as a face-to-face interaction network. FIG. 17 presents an example in which a face-to-face interaction network in a certain school is drawn, for example, including four classes (C1, C2, C3, C4), the nodes of which are drawn indifferent shapes and colors, so that each class can be identified.

Class IDs in the class ID field 1702 correspond to class IDs stored in the user attribute database 211.

In the field 1703 for degrees per class, which is labeled as, e.g., “no. of face-to-face persons”, an average degree for each class is displayed.

In the field 1704 for clustering coefficients per class, which is labeled as, e.g., “closeness degree”, an average clustering coefficient for each class is displayed.

In the field 1705 for a proposed policy message for improving scholastic performance, an appropriate message is displayed, selected from several messages which have been prepared in advance for, e.g., a class having poor scholastic performance and whose degree and clustering coefficient are small, referring to the degrees and clustering coefficients per class. In the example of FIG. 17, a message “Call to students at break” is displayed for Class C1 and a message “Provide a break room” for class C2. A message, e.g., “Keep current condition” is issued to a class having good scholastic performance and whose degree and clustering coefficient are large. In the example of FIG. 17, the message “Keep current condition” is displayed for classes C3 and C4.

Although the example of a feedback screen intended for teachers is presented in FIG. 17, in a case where this screen is replaced with a feedback screen intended for students or parents, for example, a message such as “Let's chat a little more with your classmates to cheer yourself up” may be displayed in the field 1705 for a proposed policy message.

### <Simulation Experiment Results>

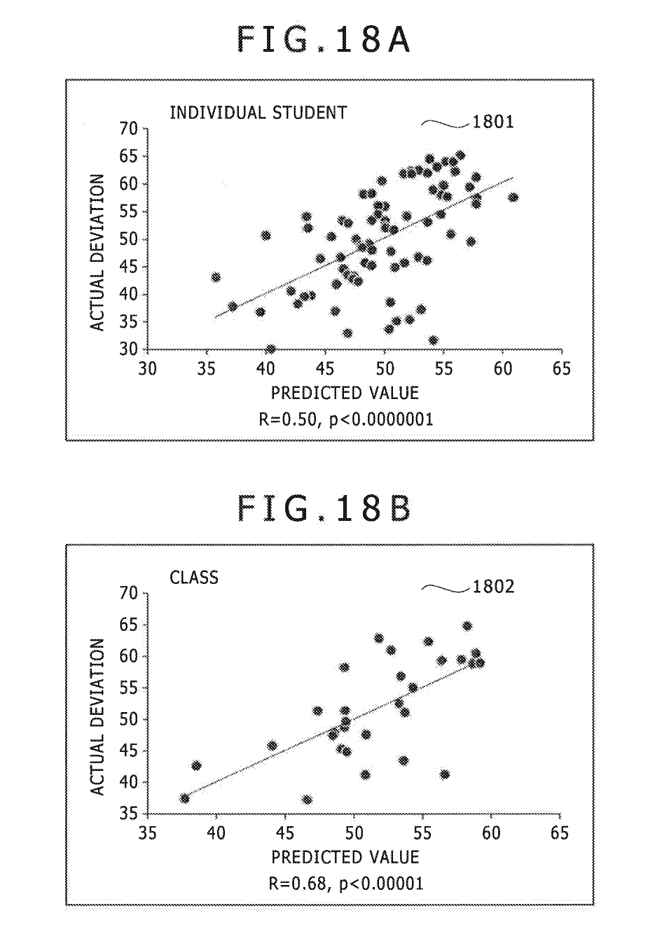

Using FIGS. 18A and 18B, then, descriptions are provided about results of a simulation experiment based on results of analysis processes described previously.

By using some factors correlating with scholastic performance, identified through the use of the method for identifying a factor correlating with scholastic performance and the system for presenting such factor according to the present embodiment, it is possible to predict scholastic performance, namely, test scores, by a method such as a multiple regression analysis.

FIGS. 18A and 18B are scatter diagrams presenting examples of simulation experiment results. In FIGS. 18A and 18B, more specifically, after predicting test deviation values for each individual student and for each class, actual deviation values and predicted values are plotted in scatter diagrams.

In FIG. 18A, reference numeral 1801 denotes a scatter diagram representing a relation between predicted scholastic performance and actual scholastic performance for each individual student. In FIG. 18B, reference numeral 1802 denotes a scatter diagram representing a relation between predicted scholastic performance and actual scholastic performance for each class.

In FIG. 18A, predicted values of scholastic performance for each individual student are calculated by calculating a regression coefficient and an intercept by a multiple regression analysis, taking P_{↑↓}, P_{↓↓}, and the number of face-to-face persons as three explanatory variables, and calculating a regression equation. These explanatory variables each correlate with scholastic performance of an individual.

In FIG. 18B, predicted values of scholastic performance for each class are calculated by calculating a regression coefficient and an intercept by a multiple regression analysis, taking the degree of unity U and the degree and clustering coefficient in the face-to-face interaction network as three explanatory variables, and calculating a regression equation. These explanatory variables each correlate with scholastic performance of a class.

Besides the explanatory variables used in calculating predicted value presented in FIGS. 18A and 18B, if there are factors correlating with scholastic performance, identified through the use of the method for identifying a factor correlating with scholastic performance and the system for presenting such factor according to the present embodiment, predicted values may be calculated using those factors.

In FIG. 18A, there is a significant correlation (R=0.55, p<0.0000001) between the predicted values of scholastic performance and actual scholastic performance (deviation values) for each individual student, which indicates that the predicted values agree well with actual scholastic performance.

In FIG. 18B, there is a significant correlation (R=0.68, p<0.00001) between the predicted values of scholastic performance and actual scholastic performance (deviation values) for each class, which indicates that the predicted values agree well with actual scholastic performance.

As presented in FIGS. 18A and 18B, it is possible to predict scholastic performance by using the method for identifying a factor correlating with scholastic performance and the system for presenting such factor according to the present embodiment, and it is possible to perform a simulation to know which factor should be controlled and how it should be controlled to increase scholastic performance. For example, it is possible to predict how the deviation value of a class will be increased by taking a policy for promoting teacher-student unity.

Therefore, by using the method for identifying a factor correlating with scholastic performance and the system for presenting such factor according to the present embodiment, it would become possible to provide an education system in which scholastic performance can be improved by a quantitative decision and prediction based on human behavior data and using interhuman relations data between a teacher and students or among students, instead of designing classes based on past experience.

### Advantageous Effects of Embodiment

According to the method for identifying a factor correlating with scholastic performance and the system for presenting such factor according to the embodiment described hereinbefore, it is possible to identify and present a quantitative indicator that has influence on scholastic performance in educational environment. This point is described below in greater detail.

(1) According to the present embodiment, an analysis is made of relational patterns between a teacher and students and among students, based on interhuman relations graph data 102 which is face-to-face data and physical movement data 103 representing a physical quantity, between the teacher and students, measured by sensors 201 attached to the teacher and students respectively, by executing the programs 213 to 215 in the steps 105 to 107. Then, an analysis is made of correlation between the relational patterns and scholastic performance data of the students by executing the program 216 in the step 109, thus analyzing which of the relational patterns strongly correlates with scholastic performance. In this way, it would become possible to identify and present an indicator or pattern that has influence on scholastic performance in a school environment involving teachers and students, quantitatively and automatically from large amounts of human behavior data.

(2) According to the present embodiment, it is possible to analyze physical movement synchronism between a teacher and students based on physical movement data stored in the acceleration information database 210 by executing the program 213 in the step 105. It is also possible to analyze physical movement synchronism among students based on physical movement data stored in the acceleration information database 210 by executing the program 214 in the step 106. It is also possible to calculate an indicator of face-to-face communication based on interhuman relations graph data stored in the face-to-face information database 209 by executing the program 215 in the step 107. Then, based on scholastic performance data stored in the user attribute database 211, a first indicator of face-to-face communication physical movement calculated in the step 107, a second indicator of physical movement calculated in the step 105, and a third indicator of physical movement calculated in the step 106, it is possible to analyze correlation between the scholastic performance data and the first to third indicators by executing the program 216 in the step 109. In this way, it would become possible to design a system based on qualitative human behavior data, instead of a qualitative decision by experience of teachers and school operators among others.

(3) According to the present embodiment, it is possible to predict scholastic performance using an identified indicator having influence on scholastic performance and display a result of the prediction on the display device 203 in the step 101. Thereby, it would become possible to predict how scholastic performance will change by changing the relation between a teacher and students and the relation among students in school environment.

(4) According to the present embodiment, it is possible to display a policy for improving scholastic performance by controlling an identified indicator having influence on scholastic performance on the display device 203 in the step 101. Thereby, it would become possible to effectively implement designing a practical policy for improving scholastic performance by identifying an indicator based on quantitative data and presenting its correlation with scholastic performance effectively.

(5) According to the present embodiment, it is possible to identify a factor correlating with scholastic performance automatically using a computer, based on large amounts of quantitative data obtained from the sensors 201. Thus, it is possible to implement designing and verifying a policy for improving scholastic performance timely and quantitatively without conducting a questionnaire survey. Moreover, using an identified indicator or pattern, it is possible to estimate which factor should be changed and how it should be changed to improve scholastic performance.

While the embodiments of the present invention made by the present inventors have been described specifically based on its embodiment hereinbefore, it will be obvious that the embodiments of the present invention are not limited to the described embodiment and various modifications may be made thereto without departing from the scope of the invention. For example, the foregoing embodiment is one described in detail to explain the present invention clearly and the present invention is not necessarily limited to one including all components described. For a subset of the components of the embodiment, other components can be added to the subset or the subset can be removed and replaced by other components.

For instance, in the foregoing embodiment, descriptions have been provided taking a school involving teachers and students as an example of an educational environment; however, the embodiments of the present invention are not so limited and are also applicable to other educational environments such as a tutoring school and a preparatory school.

What is claimed is:

1. A system for motion analytics, comprising:
acceleration sensors;
one of infrared sensors and microphones, wherein the acceleration sensors, and the one of the infrared sensors and the microphones collectively measure real-time physical movement among at least two groups of subjects,
a processor that:
identifies test scores obtained by subjects in one of the at least two groups of subjects;
computes degrees of similarities in the real-time physical movements between the at least two groups of subjects using the acceleration sensors;
computes an amount of time during which some subjects among the at least two groups of subject are engaged in communication using the infrared sensors and/or the microphones;
analyzes a correlation between the test scores and the degrees of similarities, and between the test scores and the amount of communication time;
predicts a change of the test scores based on patterns in the analyzed correlation, and
a display device that displays the predicted change of the test scores.

2. The system according to claim 1,
wherein the acceleration sensors and the one of the infrared sensors and the microphones are included in sensor nodes of a name tag form or a watch type sensor,
wherein the sensor nodes are attached to the subjects,
wherein the real-time physical movements are a number of physical vibrations per minutes,
wherein the amount of communication time is a measured time per minutes of communication between two of the subjects, and
wherein the degrees of similarities are calculated based on a degree of coincidence of acceleration waveforms measured by the acceleration sensors.

3. The system according to claim 1,
wherein the display device displays a policy for improving the test scores by controlling the patterns that have influence on the test scores.

4. The system according to claim 1,
wherein the processor computes a relation between the degrees of similarities and the test scores by using a time sequence of up and down arrows to which an acceleration waveform representing physical movement of the one of the at least two groups of subjects in time series in converted and a time sequence of up and down arrows to which an acceleration waveform representing physical movement of each of the other of the at least two groups of subjects in time series are converted,
wherein the processor creates an interaction network which includes nodes standing for the one of the at least two groups of subjects and the other of the at least two groups of subjects and links which are drawn between nodes if the subjects corresponding to the nodes are engaged in interaction for a certain amount of time or longer, and computing relation between the degrees of similarities of the one of the at least two groups of subjects and the other of the at least two groups of subjects and the test scores by using a degree and a clustering coefficient of the nodes in the interaction network.

5. A method for analyzing motion to collectively measure real-time physical movement among at least two groups of subjects by using acceleration sensors and one of infrared sensors and microphones, the method comprising:
identifying test scores obtained by subjects in one of the at least two groups of subjects;
computing degrees of similarities in the real-time physical movements between the at least two groups of subjects using the acceleration sensors;
computing an amount of time during which some subjects among the at least two groups of subjects are engaged in communication using the infrared sensors and/or the microphones;
analyzing a correlation between the test scores and the degrees of similarities, and between the test scores and the amount of communication time;
predicting a change of the test scores based on patterns in the analyzed correlation, and
displaying the predicted change of the test scores.

6. The method according to claim 5,
wherein the acceleration sensors and the one of the infrared sensors and the microphones are included in sensor nodes of a name tag form or a watch type sensor,
wherein the sensor nodes are attached to the subjects,
wherein the real-time physical movements are a number of physical vibrations per minutes,
wherein the amount of communication time is a measured time per minutes of communication between two of the subjects, and
wherein the degrees of similarities are calculated based on a degree of coincidence of acceleration waveforms measured by the acceleration sensors.

7. The method according to claim 5,
wherein the patterns that have influence on the test scores are controlled when the predicted improvement is displayed.

8. The method according to claim 7,
wherein the step of computing the degrees of similarities includes computing a relation between the degrees of similarities and the test scores by using a time sequence of up and down arrows to which an acceleration waveform representing physical movement of the one of the at least two groups of subjects in time series is converted and a time sequence of up and down arrows to which an acceleration waveform representing physical movement of each of the other of the at least two groups of subjects in time series are converted,
wherein the step of computing the amount of time includes creating an interaction network which includes nodes standing for the one of the at least two groups of subjects and the other of the at least two groups of subjects and links which are drawn between nodes if the subjects corresponding to the nodes are engaged in interaction for a certain amount of time or longer, and computing relation between the degrees of similarities of the one of the at least two groups of subjects and the other of the at least two groups of subjects and the test scores by using a degree and a clustering coefficient of the nodes in the interaction network.
